(19) United States
(12) Patent Application Publication
(10) Pub. No.: US 2009/0024530 A1
(43) Pub. Date: Jan. 22, 2009

(54) AUTOMATIC GIFT MESSAGING SYSTEM

(75) Inventors: Dorrian Grant Porter, Menlo Park, CA (US); Dan Ackerman Greenberg, San Francisco, CA (US); Jason Carl Tokoph, Naperville, IL (US); Roger Phylos Hoover, San Mateo, CA (US); Huajun Qin, Fremont, CA (US); Jonathan Chiu, Santa Clara, CA (US)

Correspondence Address: AMIN, TUROCY & CALVIN, LLP, 127 Public Square, 57th Floor, Key Tower, CLEVELAND, OH, 44114, US

(73) Assignee: MOZES INCORPORATED, Palo Alto, CA (US)

(21) Appl. No.: 12/175,183

(22) Filed: Jul. 17, 2008

Related U.S. Application Data
(60) Provisional application No. 60/950,715, filed on Jul. 19, 2007.

(51) Int. Cl. G06Q 30/00; H04L 9/00

(52) U.S. Cl. 705/50; 705/26

(57) ABSTRACT

Electronic and automatic gifting techniques are provided for messages, such as short message service (SMS) or multimedia messaging service (MMS) messages, wherein a gifter designates a recipient for one or more gift(s) offered in a set of gifts. Based on a selection of gift(s), message(s) are automatically generated for the gift(s) having unique identifier(s) that correspond to products or services of an enabling entity that enables the products or services. The message(s) including the unique identifier(s) are then automatically transmitted to the recipient. The unique identifier(s) can be encrypted/hashed with a secret provided by the recipient for an additional layer of security. Any of gifter information, giftee information, context of the service, or external information, such as global positioning service (GPS) location, can be used to make recommendations for gifts in the set of gifts.

### CROSS REFERENCE TO RELATED APPLICATIONS

This application claims priority to U.S. Provisional Patent Application Ser. No. 60/950,715, filed on Jul. 19, 2007, entitled “AUTOMATIC GIFT MESSAGING SYSTEM”, the entirety of which is incorporated herein by reference.

### TECHNICAL FIELD

The subject disclosure generally relates to automatic gifting to mobile devices by selecting one or more gifts via a host environment or service.

### BACKGROUND

The explosive growth in digital content and e-commerce in the nineties and the present decade has been accompanied by a number of systems and corresponding processes for storing, managing and retrieving content in various electronic formats and in a variety of ways. Storing and managing all types of content, including documents, images, video, audio and the like, typically occurs inside of a content management application incorporating some type of a database, and which may be operated in a private network or on the Internet. With existing systems, retrieving the digital content from oneself or another content owner typically requires a person either to search for a document on a personal computer, a private network or the Internet, or to provide contact information (an Internet address, email address or instant message identifier) to the content owner so that the digital content can be delivered, received and enjoyed by that person.

Likewise, commercial transactions on the Internet or over the phone typically occur in one-to-one setting in which a buyer must conduct a transaction on a seller's own website or by speaking to a live operator. When doing so, the buyer must enter, re-enter or store a significant amount of personal information. Moreover, when a consumer sees something outside the Internet, like a seller's offline advertisement (such as a billboard, magazine or elsewhere), the consumer must almost always visit the Internet, place a voice telephone call, or visit a seller's physical site. In many cases, the buyer is repeatedly shopping from the same seller and repeating many of the same time-consuming steps to conduct a transaction.

At the same time as the amount of content and e-commerce expands dramatically, people are increasingly relying on mobile devices as a primary means to communicate via voice, text, Internet enabled browsers or Internet enabled services like instant messaging. It can be appreciated that mobile devices are generally used because they are portable and convenient, and they are becoming near ubiquitous in their adoption by people all over the world. Yet, mobile devices, such as mobile phones, are often limited in their ability to navigate, retrieve and act on content or other data due to their portability, and corresponding limited input interface and storage capacities. With the enormous growth in both content availability and e-commerce, there is thus an emerging need on the part of content owners and commerce providers to obtain the content or conduct a transaction in a more simple, convenient, accurate and cost effective way.

Some existing services seek to connect requests for digital content or data to the direct delivery of content or data to the mobile device for immediate use or action, which the user may or may not be ready to take. Thus, there is an inherent disconnect in such systems between what the user may want and the ultimate timing of the delivery of the content by the content owner. In addition, these services lack an efficient way to communicate a request for specific information about which the user has just learned. Two main problems thus present themselves with respect to such existing systems. First, such systems are inefficient because they are overloaded with unwanted or irrelevant amounts of digital content or data. Second, such systems are dramatically limited in terms of the actions that a user may take with respect to such digital content or data.

Likewise, similar quandaries exist with respect to sending gifts to other people, i.e., today, a person typically searches for a suitable gift from a specific vendor web site, or vendor aggregator, and then initiates a complex transaction to purchase a gift for a third party. The transaction for sending the gift to the third party includes informational requirements such as “shipping address,” which can be inconvenient given how mobile the modern workplace is and how often people move. Some third party vendors also allow gifts to be emailed to a recipient at their email address, rather than physical address, though again complicated transactions are required including a requirement that an exact email address be provided for the exact recipient. Given most people maintain multiple email addresses, work, personal, etc., which come and go even more regularly than physical addresses as people change jobs, internet service providers, etc., it is often difficult to know what the best email address is to use when sending a gift to someone.

The above-described deficiencies of current designs for electronic gifting are merely intended to provide an overview of some of the problems of today's systems, and are not intended to be exhaustive. Other problems with the state of the art and corresponding benefits of the invention may become further apparent upon review of the following description of various non-limiting embodiments of the invention.

### SUMMARY

Electronic and automatic gifting techniques are provided for messages, such as SMS or MMS messages, wherein a gifter designates a recipient for one or more gift(s) offered in a set of gifts. Based on a selection of gift(s), message(s) are automatically generated for the gift(s) having unique identifier(s) that correspond to products or services of an enabling entity that enables the products or services. The message(s) including the unique identifier(s) are then automatically transmitted to the recipient. The unique identifier(s) can be encrypted/hashed with a secret provided by the recipient for an additional layer of security. In other embodiments, any of gifter information, giftee information, context of the service, or external information, such as global positioning service (GPS) location, can be used to make recommendations for gifts in the set of gifts.

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments of the invention in a simplified form as a prelude to the more detailed description of the various embodiments of the invention that follows.

### BRIEF DESCRIPTION OF THE DRAWINGS

The text message gifting systems and methods of the invention are further described with reference to the accompanying drawings in which:

FIGS. 1A, 1B, 1C and 1D are block diagrams illustrating non-limiting embodiments of the invention for message gifting;

FIG. 2 is a block diagram illustrating exemplary aspects of a recommendation engine in accordance with the invention;

FIG. 3A, 3B, 3C, 3D and 3E are block diagrams showing further aspects of recommending and sending gifts to a giftee from a gifter via message in accordance with the invention;

FIG. 4A illustrates various exemplary non-limiting types of gifts that can be enabled with message gifting in accordance with the invention;

FIG. 4B illustrates an embodiment of the invention using multimedia messaging service (MMS) gift messages;

FIG. 4C illustrates an embodiment of the invention using wireless application protocol (WAP) gift messages;

FIG. 4D illustrates an embodiment of the invention wherein the gifter indicates a gift for a giftee from a mobile device instead of a hosted environment;

FIG. 5 illustrates a system level block diagram of a content management system that can implement message gifting in accordance with the present invention;

FIG. 6 illustrates a system level block diagram showing storage relationships of the system from keywords to content or content links to content owners in accordance with an exemplary host environment;

FIG. 7 illustrates exemplary aspects of keyword utilization and storage in accordance with an exemplary host environment;

FIG. 8 illustrates an exemplary non-limiting flow diagram of keyword/content association methods of an exemplary host environment;

FIG. 9 illustrates an exemplary non-limiting flow diagram showing user interactions with content according to retrieval and configuration aspects of an exemplary host environment;

FIG. 10 illustrates an exemplary non-limiting flow diagram showing content retrieval via keyword processes enabled by content management systems or services as a hosted environment for the invention;

FIG. 11 illustrates an exemplary non-limiting flow diagram showing purchasing processes enabled by an exemplary hosting environment having content management systems or services;

FIG. 12 illustrates an exemplary non-limiting flow diagram showing group sharing processes enabled by an exemplary host environment having content management systems or services;

FIG. 13A illustrates an overview of a network environment suitable for service by embodiments of the invention;

FIG. 13B illustrates a GPRS network architecture that may incorporate various aspects of communications in accordance with the invention; and

FIG. 14 illustrates an alternate block diagram of an exemplary GSM/GPRS/IP multimedia network architecture in which the invention can be deployed.

### DETAILED DESCRIPTION

### Overview

As discussed in the background, conventional on-line gifting mechanisms require the gifter to know current information about their physical address or electronic mail address. Since physical and electronic mail addresses can change a lot and are thus difficult to remember, what would be desirable is a simple way to transmit a gift to a recipient without being required to know a lot about the person.

In consideration of this shortcoming and others in the state of the art of electronic gifting, the invention provides a message application or UI control that can be incorporated into a host web site or web service infrastructure. The message application or UI enables a gifter to select one or more gifts for a friend (any third person) from a list of gifts. Selection of the one or more gifts automatically causes gift message(s) to be sent, via short message service (SMS) message(s), to the friend without further action on the part of the gifter, and without any requirement of knowing a current email or mailing address for the recipient. In this respect, the host web site or web service pre-associates the mobile number(s) of giftee(s) to the giftee(s) so that when a potential gifter designates one of the giftee(s), or when the context of a gifter's actions or state on the web site or service indicate a particular giftee, gift messages occur automatically to the gifter without requiring the gifter to remember the mobile number(s).

In various non-limiting embodiments, a gift message includes a product, service or gift code that uniquely identifies a corresponding product, service or gift. When the code is presented to the appropriate product, service or gift provider from a mobile device that receives the gift message, validation of the gift code by the appropriate provider determines whether the gift is valid towards the corresponding product, service or gift. In one embodiment, the gift code can be encrypted or hashed via an algorithm that obscures the gift code information. With one option, the giftee's mobile phone number can be a number used during encryption or hashing algorithm execution. With another option, the giftee can specify a secret, such as a password, to a host system, so that the secret is automatically used when encrypting/hashing and sending gift messages in accordance with the invention.

Embodiments can include a gift recommendation engine that recommends gifts to a potential gifter contemplating a gift to a giftee. The recommended gifts can be based on external information (e.g., time of day, GPS location), information from the gifter (e.g., gifter selected context, filter for gifts, etc.) and/or information about the giftee (e.g., giftee preferences, transaction history, gift history, demographic information, etc.).

Various embodiments described below are described in the context of text messages to a recipient mobile device. However, any of the embodiments herein can employ other kinds of communications as well. For instance, MMS communications can be used as an alternative to SMS communications. For instance, instead of a text message, an MMS message can be substituted that includes the unique code as described in the text message embodiments below. For instance, an MMS message may include a visual card or coupon object including graphics, text, etc. that includes a gift code. The gift code can be represented in an image format (e.g., overlay graphic, watermark, etc), or text format (e.g., conventional ASCII codes). Other wireless application protocol (WAP) specifications can also be used for communicating gift codes to a recipient mobile device as well.

Other exemplary aspects and embodiments of automatic gift messaging in accordance with the invention will become apparent from the following detailed description of the invention.

### Automatic Gift Messaging

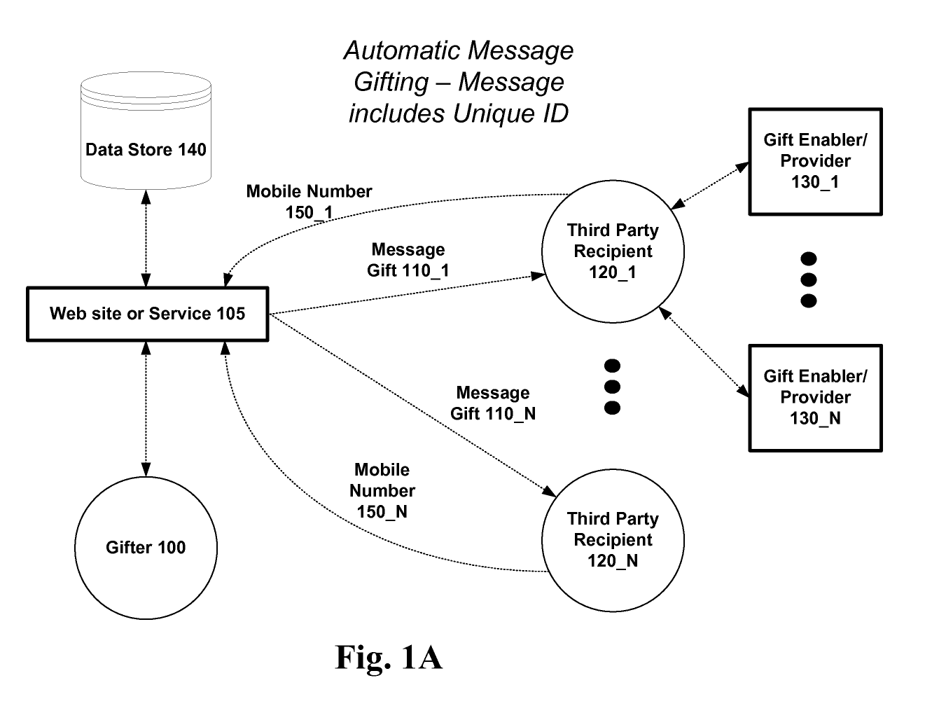

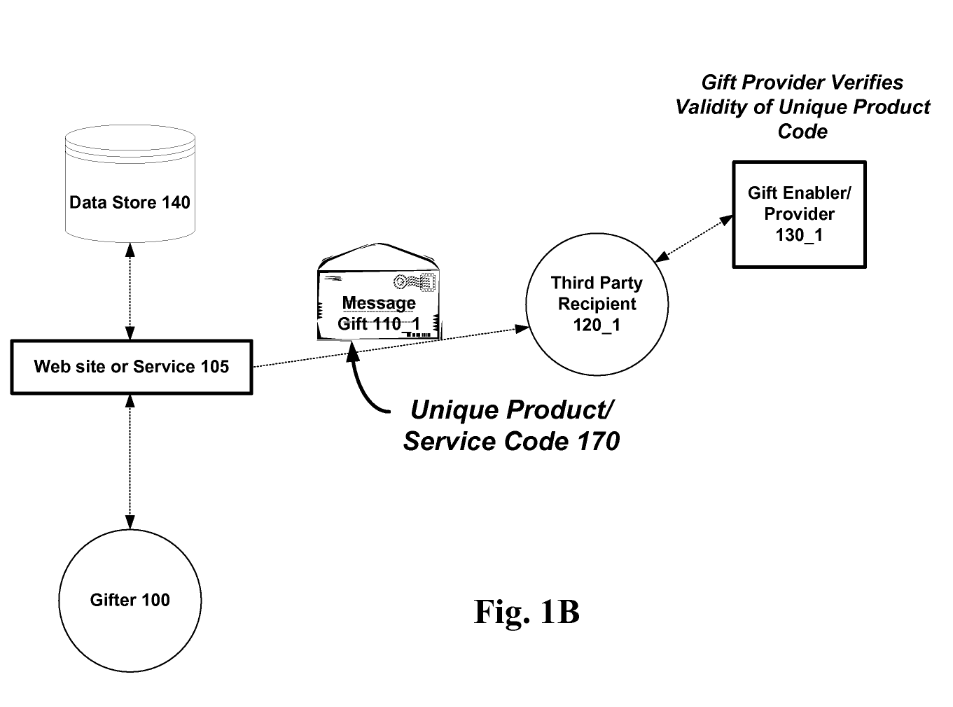

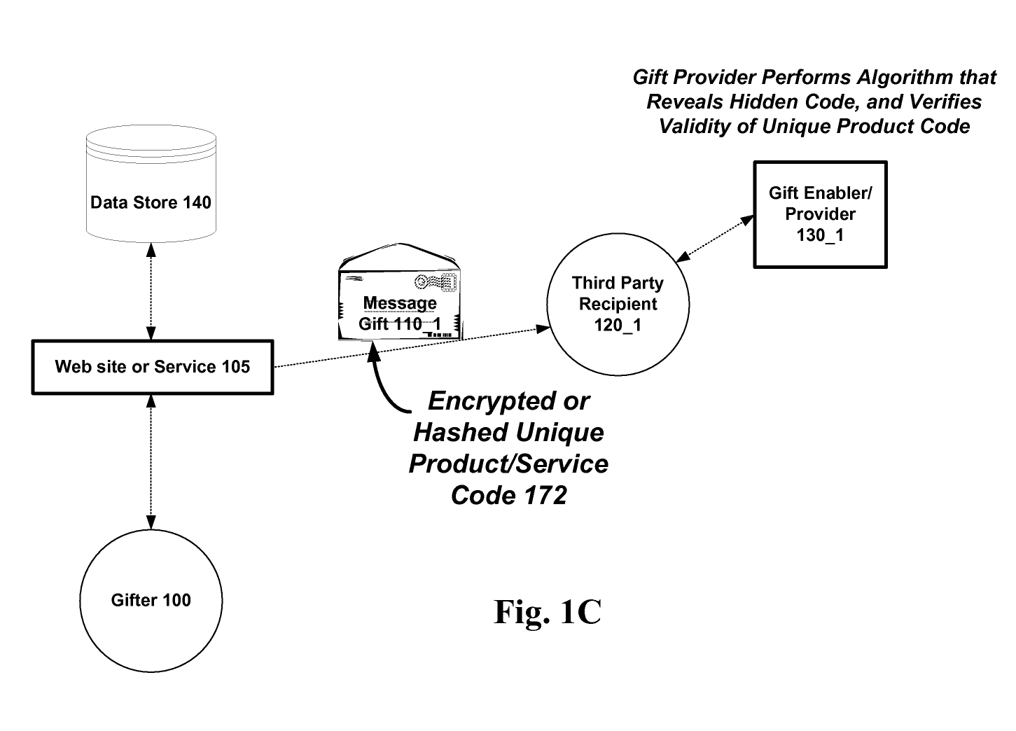

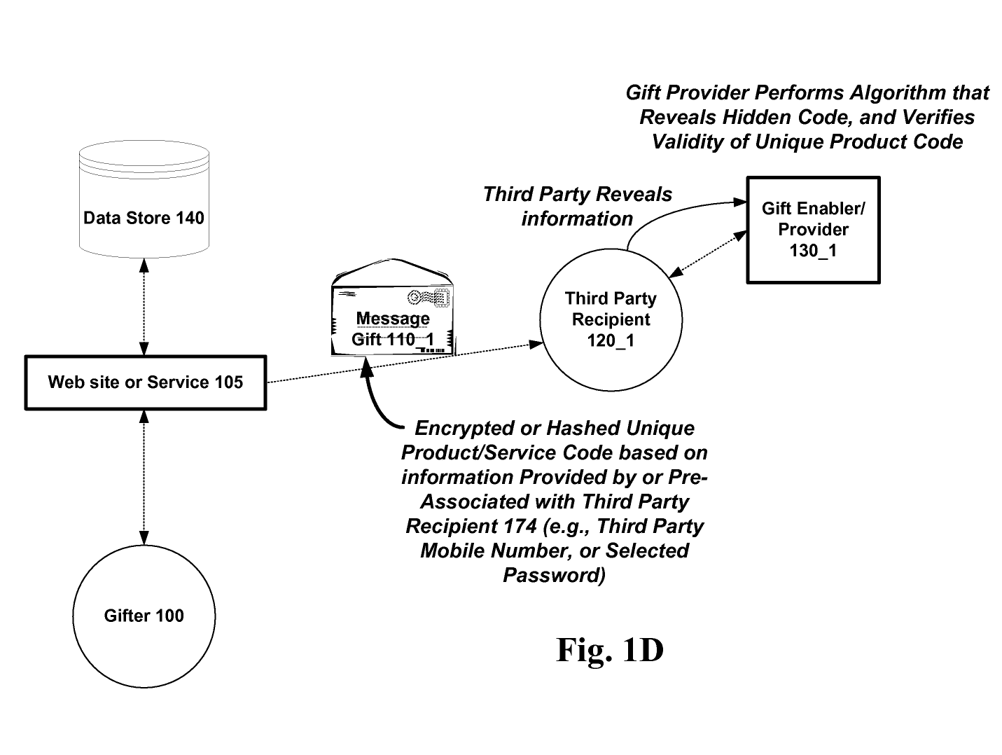

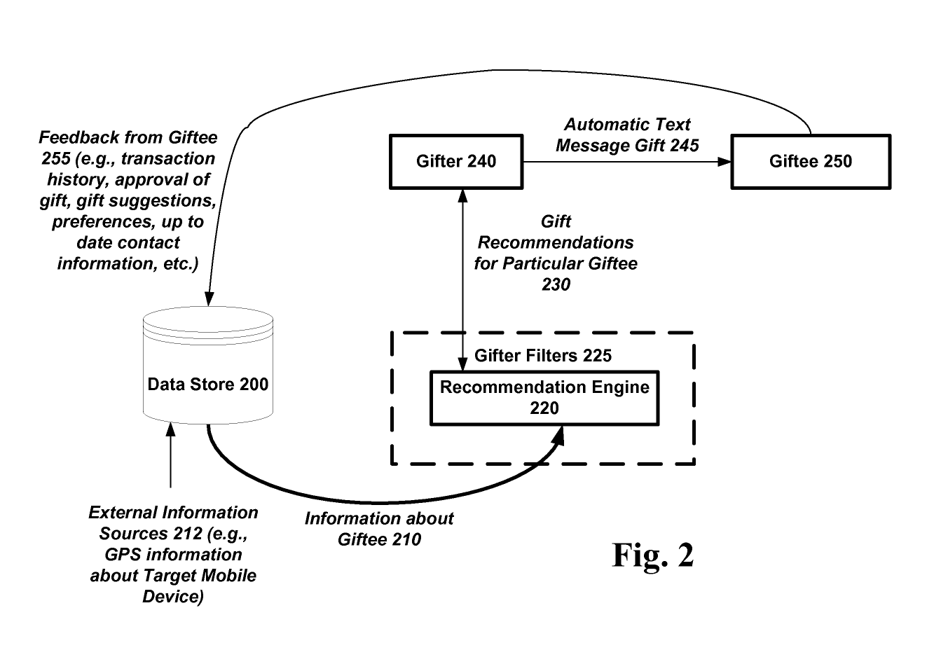

In this regard, in various non-limiting embodiments, as shown in FIG. 1A, the invention enables automatic message gifting where a gifter 100 selects, via a web site or service 105, one or more gifts to send to any of one or more third party recipients 120_1, . . . , 120_N in gift messages 110_1, . . . , 110_N, respectively. In consultation with data store 140, which includes the mobile numbers 150_1, . . . , 150_N of the third party recipients 120_1, . . . , 120_N, when a gifter selects a gift for one of the third party recipients 120_1, . . . , 120_N, a message is automatically generated to the target's mobile number that includes a unique identifier corresponding to a gift (e.g., product, service, etc.). Then, upon a third party recipient 120_1, . . . , 120_N receiving a message gift 110_1, . . . , 110_N, respectively, the third party recipient can redeem the gift at the appropriate gift enabler or provider 130_1, . . . , 130_N, respectively.

As shown in FIG. 1B, a message gift 110_1 can be automatically generated in response to gifter 100 selecting a gift at web site or service 105. In various non-limiting embodiments, each message gift 110_1 includes one or more unique product or service codes 170, which, when revealed to the corresponding gift enabler/provider 130_1 as a valid code, serve as credit for participating product(s) and/or service(s) offered by gift enable/provider 130_1 to the third party recipient 120_1.

Considering that theft of mobile devices is ever mounting, in effect, when a mobile device is lost or stolen, a receiver of the mobile device can use any credit accrued to the mobile device user's account by simply revealing the gift codes 170 received by the corresponding mobile device. Thus, as shown in FIG. 1C, in one embodiment, the unique product/service code(s) 172 are encrypted or hashed so that the code is obscured from a casual observer of the message, or reads as nonsense. Then, when third party recipient 120_1 takes the mobile device to the store, an algorithm can be applied that interprets the message only if a pre-condition is met by the presenter of the device.

A non-limiting embodiment of FIG. 1C is illustrated in FIG. 1D. More specifically, a unique product or service code automatically delivered via message in accordance with the invention may be encrypted or hashed based on information 174 provided by the third party recipient to the system. For instance, information 174 could be the third party recipient's mobile device number, or a password selected by the third party recipient. Thus, if third party recipient presents a product code from a message gift 110_1, but does not have information 174 that properly reveals the underlying code as a valid code to gift enabler/provider 130_1, then third party recipient 120_1 fails to be able to use the code for lacking the secret. In this manner, theft safeguards are integrated into such embodiments to prevent robbers from benefiting from gifts on mobile devices.

In yet another embodiment, a lost or stolen mobile device can be reported so that if a thief tries to use one of the unique gift codes in any messages on a stolen mobile device, the unique gift code will signal improper use of gift codes and invalidate the transaction, and/or trigger law enforcement activity or notification.

In other non-limiting embodiments of the invention, as illustrated by the block diagram of FIG. 2, a variety of inputs can be received by a recommendation engine 220 from which information 210 about the giftee, or information 210 about gifts for the giftee, can be ascertained. As a data abstraction, data store 200 represents any and all storage sources, remote or local, from which information 210 is obtained. Data store 200 can include feedback 255 from the giftee, either directly or indirectly given through participation in the hosted environment. Feedback 255 can be explicitly or implicitly provided by giftee 250. In this regard, some additional processing, e.g., collaborative filtering and other recommendation algorithms, may or may not be necessary to make feedback 255 useful for making a gift recommendation.

For instance, the giftee 250 may provide information about transaction history, approved gifts, gift suggestions, preferences, up to date contact information, demographic or other statistical information, or the like. Other source 212 for input to data store 200 can include external information such as global positioning system (GPS) information, or calendar/holiday information, e.g., on Halloween, recommend spooky costume gifts.

Then, based on information 255 and/or information 212, information 210 about the giftee is received by recommendation engine 220 when an opportunity to gift via text messaging is provided in the hosted environment. Recommendation engine 220 operates to make gift recommendations 230 for the particular giftee 250 to gifter 240. The gift recommendations can be further based on gifter filters 225, which specify further constraints on gifts for possible gifting to giftee 250, e.g., a gifter filter 225 by the gifter can specify that the gifts should all be in a “sports” category, or as in the exampled described herein below, that the gifts should all be in a “Simpsons movie” category. Having produced a set, e.g., a list, of gifts fulfilling any function based on one or more of feedback 255, external information 212 and/or gifter filters 225, gifter 240 selects a gift from the list. In turn, since the hosted environment is aware of the delivery mobile number for a text message for giftee 250, a gift text message 245 based on the selected gift is automatically sent to the giftee 250.

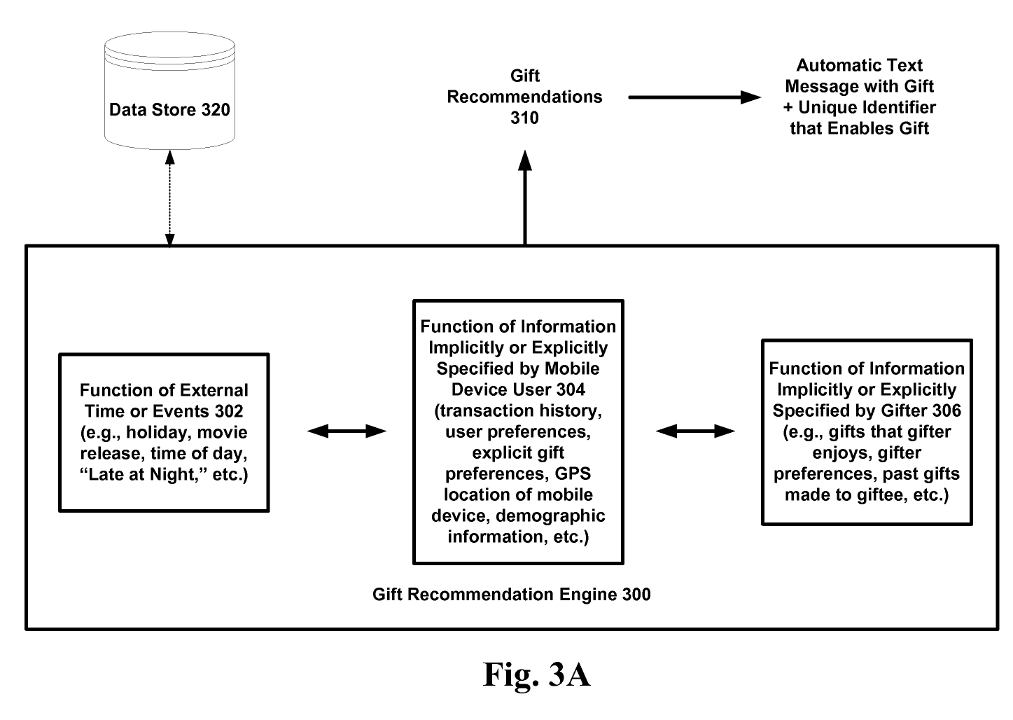

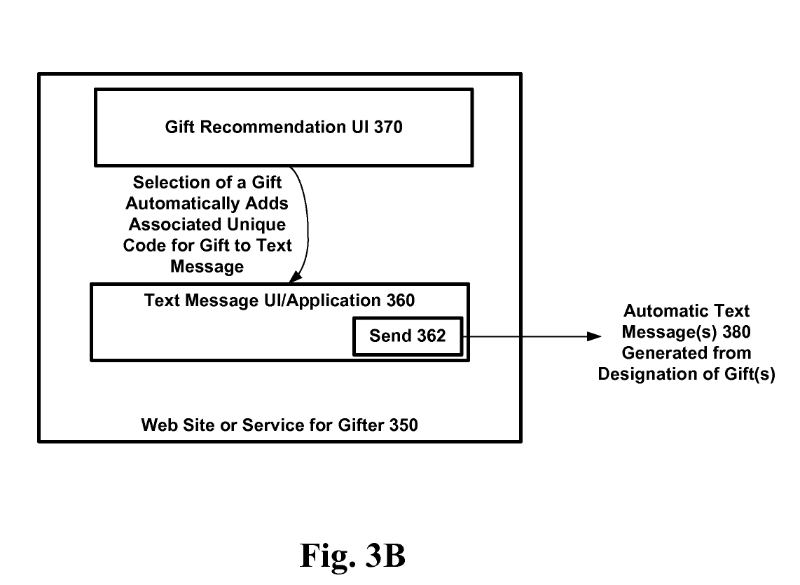

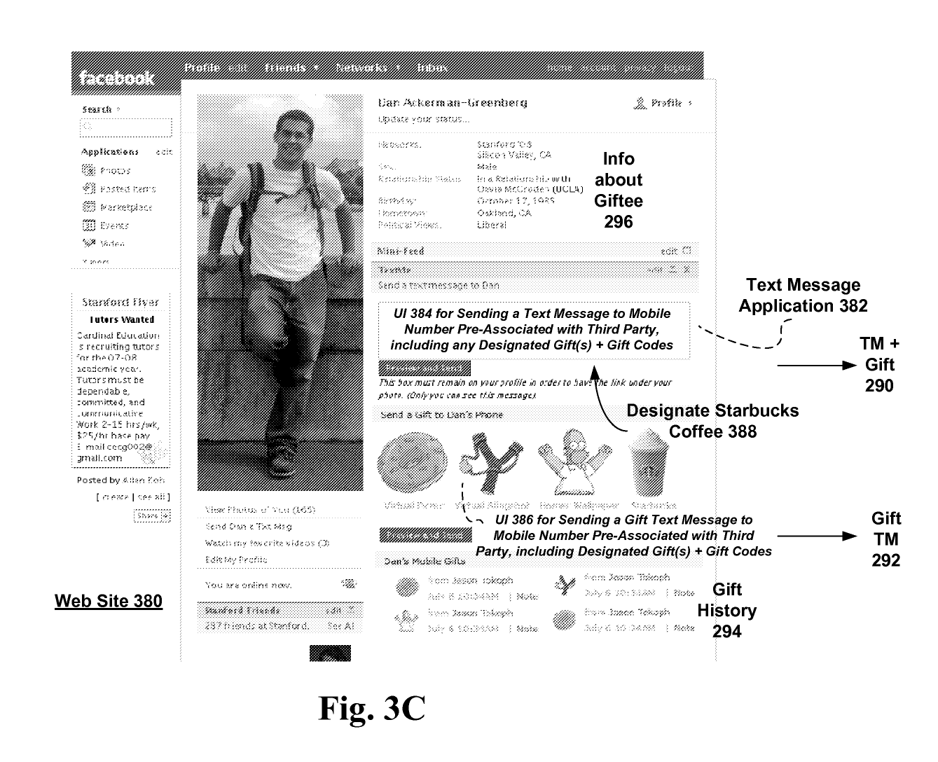

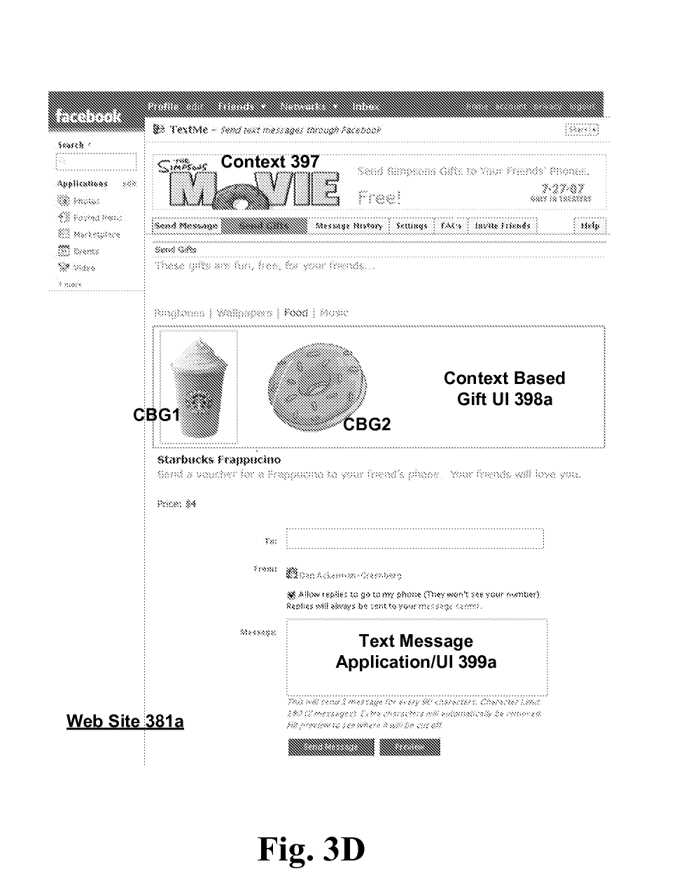

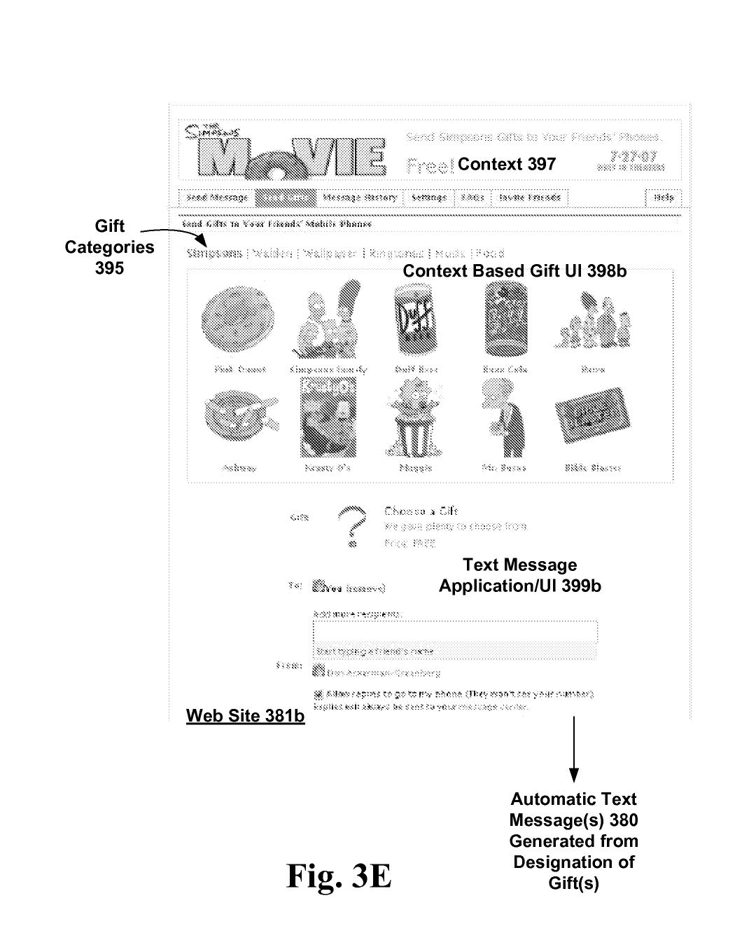

FIG. 3A, in turn, illustrates further aspects of an exemplary gift recommendation engine 300 in accordance with the invention. In this regard, as mentioned, data store 320 includes gifter data, giftee data, transaction data, external data, etc. on behalf of a system implementing gift recommendation in accordance with the invention, however data store 320 is depicted as a single entity merely for convenience, and can comprise multiple locations, stores, whether remote or local.

In one non-limiting embodiment, there are three main areas of information that can be configured for use in connection with recommending gifts for automatic gift text messaging in accordance with the invention. As shown, engine 300 can make recommendations based on one or more functions of external information 302, such as times or events, e.g., holiday, movie release, time of day, such as “Late at Night,” or similar external information. Engine 300 can also optionally make recommendations as one or more functions of information implicitly or explicitly specified by mobile device user 304. For example, information 304 includes transaction history, user preferences, gifting history, explicit gift preferences, GPS location of mobile device, demographic or other statistical information, and so on. As a third area, gift recommendation engine 300 can also make recommendations based on one or more functions information implicitly or explicitly specified by a gifter 306. Information 306, for instance, can include information that specifies gifts that the gifter enjoys, gifter preference information, information about past gifts, or any other filter over gifts or gift categories for presentation and recommendation to the gifter.

An automatic text message gifting system or application in accordance with the invention can be included in any hosted environment. In one embodiment, the invention includes software that can be included in any hosted environment, such as a web site, or web service, that enables the hosted environment to permit gift text messaging as described in various embodiments herein. For instance, a web site or service for gifter 350, as shown in FIG. 3B, can include a text messaging UI component 360 for sending text messages to a designated giftee. Once a gifter sets up payment information, such as credit card information to cover the gift, when a gifter selects a gift in accordance with the invention, the gift text message 380 is sent to the giftee automatically. In one embodiment, prior to automatically sending the gift message 380, the gifter presses a send control 362, which then causes the gift message to be sent automatically.

As further illustrated in FIG. 3B, the invention can be accompanied by a gift recommendation UI 370, which can make intelligent gift recommendations based on a variety of functions as described in connection with FIG. 3A above. After recommending a set of gifts to a gifter in UI 370, the gifter can select one or more of the gifts to send to a designated giftee, causing the text message(s) 380 to be sent automatically to the giftee's mobile device. As described elsewhere, the recipient or giftee's mobile device can then be used to gain access to third party product or service providers' products and services covered by the gift code(s) contained in the text messages 380 received by the giftee's mobile device.

FIG. 3C is a screenshot of an exemplary, non-limiting hosting environment for the invention. For instance, a web site 380 (www.facebook.com) includes various hosted information 296 about a prospective giftee, which can be used in connection with recommending gifts. Gift history 294 is also illustrated, which can also be used in connection with recommending gifts in UI 386.

A text message application 382 can be incorporated into a page of web site 380 so that a prospective gifter can select gifts and create text message gifts for delivery to the giftee. A text message can either be a typical text message generated by the gifter (e.g., text) accompanied by gift code(s) associated with the gift(s) selected by the gifter, as in the case of TM+Gift 290, or a gift TM 292 can be sent which is automatically generated without additional texting from the gifter. A text message can be entered by the gifter in UI 384 for sending text messages, which may also include gift codes.

UI 386 can be used to select and send a gift text message to a mobile number pre-associated with a third party, including a description of the designated gift(s) and gift code(s). Thus, for instance, in the screenshot of FIG. 3C, the hosted environment 380 displays a friend, Dan Ackerman Greenberg. Information 296 about Dan and gift history 294 for Dan are displayed. A gift recommendation engine underlying UI 386 determines that Dan likes the Simpsons, and displays Simpsons gifts as a result.

Then, a gifter can designate starbucks coffee 388, and cause a text message to be sent including the appropriate gift code that can be redeemed at Starbucks locations under gift criteria that can be associated with a gift code, much like real world coupons, e.g., expiration dates, restriction on number of purchases, etc. Since the page is already based on the giftee, the giftee's mobile number is automatically understood by the text messaging application 382 to be the target number. Advantageously, this number is maintained by the giftee and is thus up to date, and the gifter need not memorize the number.

FIG. 3D illustrates that context 397 of a hosted environment 381a can be used to trigger the use of text message gifting UI 399a in accordance with the invention. For instance, a potential gifter can be browsing with a browser when the gifter encounters a trailer for the upcoming Simpsons movie. As a result of the selection of the gifting context, context based gift UI 398a displays content based gift CBG1 (Starbucks coffee) and content based gift CBG2 (a pink donut). As in the other embodiments described herein, a gifter can then use text message application UI 399a and/or context based gift UI 398a to select a gift, which causes a gift text message to be sent to the target mobile device.

FIG. 3E illustrates another contextual example wherein the context 397 is determined by prospective gifter viewing web site 381b. For instance, by changing the gift categories to be displayed relevant to a context 397, such as the Simpsons movie, a variety of context based gifts can be displayed in context based gift UI 398b. For instance, different kinds of Simpsons Gift categories include Virtual Gifts, Pink Donut, Duff Beer, Buzz Cola, etc., Ringtones, Mobile Wallpapers, 7-11/Kwik-E-Mart, 1 Free Donut, 1 Free Squishee, Paid Mobile Content, Simpsons Game. In conjunction with text message application/UI 399b, text message(s) 380 are automatically generated as described elsewhere herein.

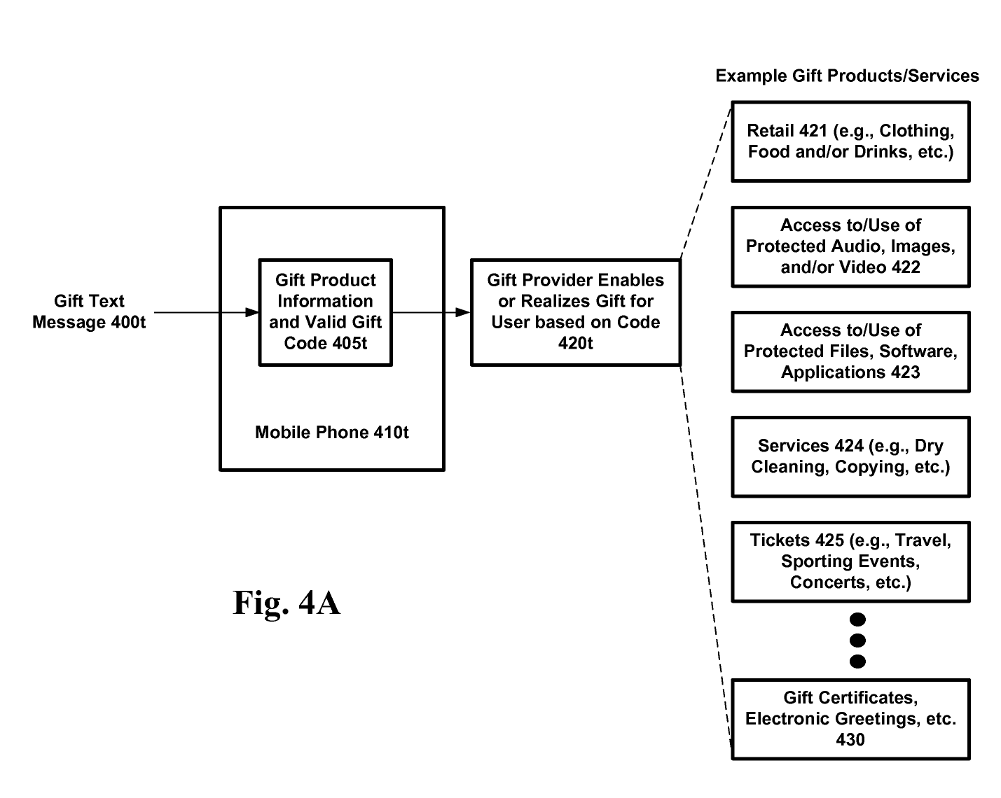

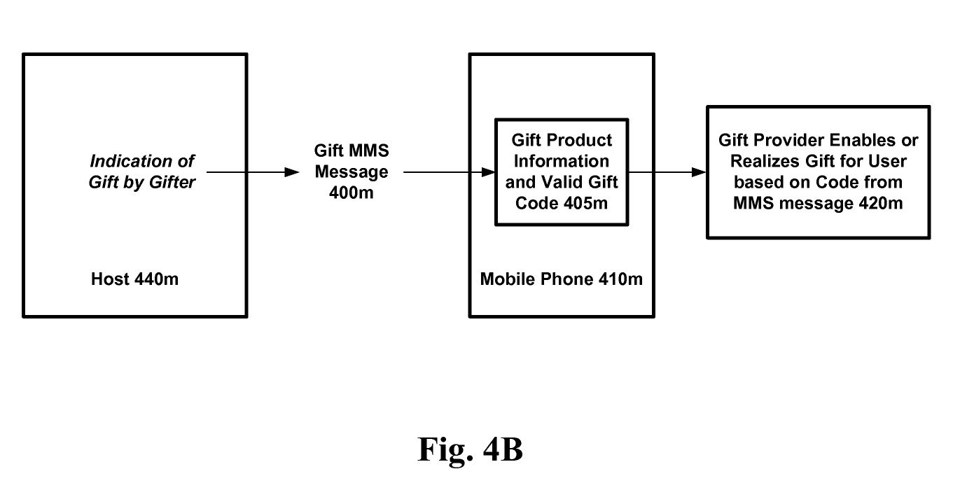

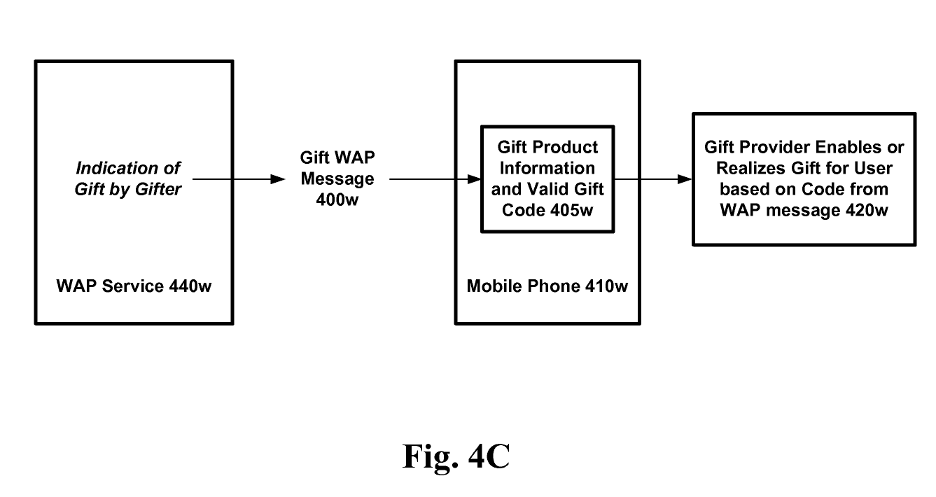

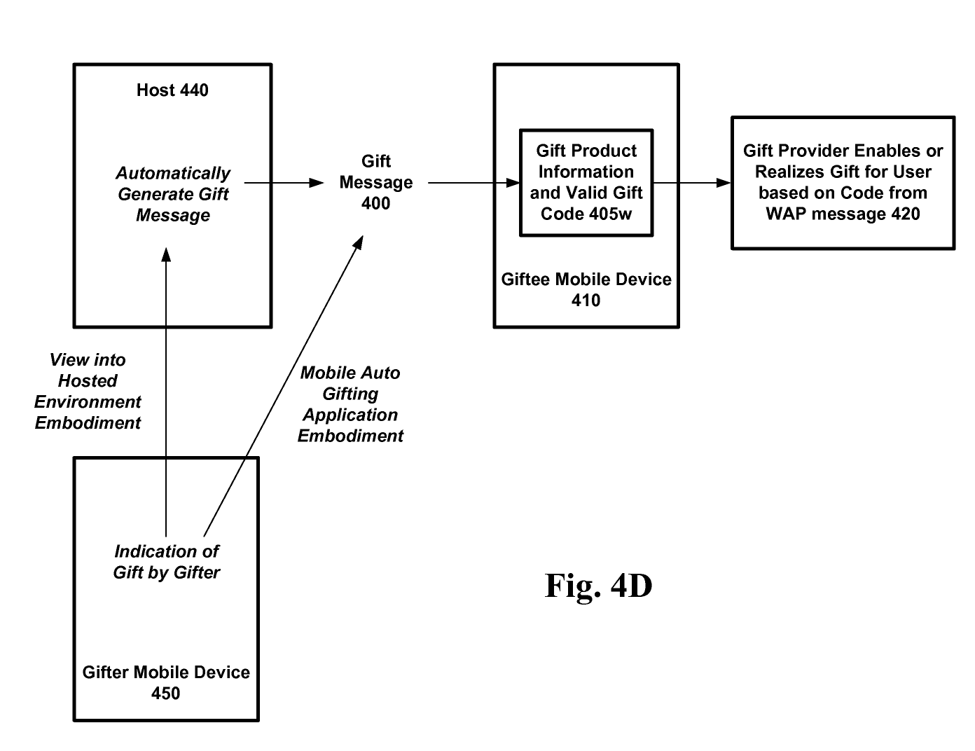

FIG. 4A illustrates some exemplary, non-limiting categories of gifts in accordance with an embodiment of the invention employing text messages. In this regard, to use an incoming gift text message 400t received by a recipient's mobile phone 410t, the gift code information and gift code 405t included in the gift text message 400t are verified by the gift provider in order enable or realize the gift for the giftee at 420t. Once verified, a whole host of products or services is contemplated. For instance, categories include retail 421, multimedia 422, software 423, services 424, tickets 425, gift certificates 430, and so on.

As mentioned, instead of a text message, an MMS message can be substituted that includes the unique code as described in the text message. For instance, an MMS message may include a visual card or coupon object including graphics, text, etc. that includes a gift code. In this regard, MMS messages support a wide range of content and any MMS message that includes a gift code redeemable at a store, retailer, provider, etc. is contemplated by the invention. For some non-limiting examples, the gift code can be represented in an image format (e.g., overlay graphic, watermark, etc), or text format (e.g., conventional ASCII codes). As shown in FIG. 4B, to use an incoming gift MMS message 400m received by a recipient's mobile phone 410m in automatic response to a gifter designating a gift in hosted environment 440m, the gift code information and gift code 405m included in the gift MMS message 400m are verified by the gift provider in order enable or realize the gift for the giftee at 420m.

Other wireless application protocol (WAP) specifications can also be used for communicating gift codes to a recipient mobile device as well. For instance, as shown in FIG. 4C, to use an incoming gift WAP message 400w received by a recipient's mobile phone 410w in automatic response to a gifter designating a gift in hosted WAP service 440w, the gift code information and gift code 405w included in the gift WAP message 400w are verified by the gift provider in order enable or realize the gift for the giftee at 420w.

A WAP browser provides all of the basic services of a computer based web browser but is simplified to operate within the restrictions of a device, such as a mobile phone. WAP is now the protocol used for the majority of the world's mobile internet sites, known as WAP sites. Any of the WAP protocols can be used to automatically generate gift messages in accordance with the invention. For instance, WAP Push allows WAP content to be pushed to the mobile handset with minimum user intervention. A WAP Push is basically a specially encoded message which includes a link to a WAP address. A WAP Push can be used to automatically send gifts in accordance with the invention.

The above-described WAP embodiments thus do not require a web site in the traditional sense, and accordingly, it can be appreciated that the invention is not limited to web site or web service embodiments. Rather, the invention may be practiced from a gifter's mobile device as well. Accordingly, FIG. 4D illustrates an embodiment of the invention wherein the gifter indicates a gift for a giftee from a mobile device instead of a hosted environment. As shown, a gifter makes a designation of a gift on the gifter's mobile device 450 in a context that indicates the giftee's mobile device as a target for automatically generating a gift message. This indication can be as part of a view into a hosted environment 440 (e.g., a server based implementation) which in turn generates the gift message 400, or a mobile automatic gifting application can automatically generate the gift message 400 directly from the gifter's mobile device 410. As with other embodiments described herein, to use an incoming gift message 400 received by a recipient's mobile phone 410 in automatic response to a gifter designating a gift from mobile device 450, the gift code information and gift code 405 included in the gift message 400 are verified by the gift provider in order enable or realize the gift for the giftee at 420.

### Non-Limiting Hosting Environments for Gift Text Messaging

For the avoidance of doubt, any of the embodiments described herein can be included in any host environment, e.g., web site or service. In some embodiments, the host environment has other existing relationships to mobile device users already, which can help inform the gifting recommendation process as well.

For instance, the invention can be incorporated into a hosted environment such as a content request, storage and configuration system, which loads and stores different types of content, associates each piece of content with one or more keywords and configures the content in particular ways for the benefit of a user. Content owners load content into the system or reference (e.g., link to) content from elsewhere, and keywords are assigned to the content by the system based on user input and/or auto-generation acts taken by the system.

In various exemplary non-limiting embodiments, a tag representing the keywords is associated with the content and stored in the system. Short Message Service (SMS), email, instant messaging, a designated entry point on a personal computer or mobile web browser, or other methods may be used by a user to communicate the one or more pre-assigned keywords in order to indicate user interest in a particular content item or items. Receipt by the system of the keywords from the user initiates identification and retrieval of relevant piece(s) of content by the system, and association of the content with the user making the request. Then, if desired by the user or if otherwise appropriate, the system operates to configure a user's account to take specific actions with respect to the content.

The user may also assign his or her own keywords to aid in the use of the system, and establish pre-defined additional actions that the system may take based on receipt of the keyword by the user. In one non-limiting embodiment, a user can send a request to purchase a particular content item or items with the use of keywords, the system having been pre-configured to execute a purchase transaction upon receipt of such keywords. In another non-limiting embodiment, a user can configure the system so that the send, or transmission, of the keyword triggers the deposit of the associated content in the account of another user or accounts of a group of users, or otherwise authorizes the other user(s) to interact with the content in a specified way.

The gifting techniques of the invention can thus be coupled with requesting digital content or data via the use of keywords and a system capable of retrieving, storing and configuring digital content or data based on the keywords or identity of the user. As used herein, the term “digital content or data” includes any one or more text, audio, video, image and data files including, but not limited to, database information, information worker files, such as spreadsheet files, markup language documents, such as XML, or any combination of such digital content or data.

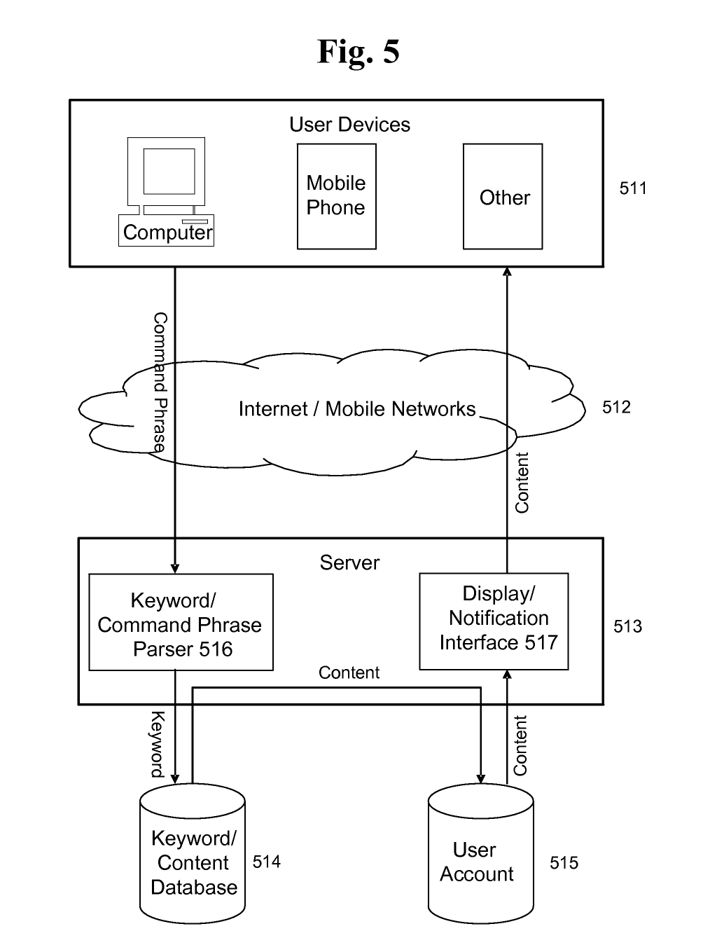

FIG. 5 is a diagram illustrating an exemplary host environment or system. Other organizations will be known to those skilled in the art and also within the scope. There is no limit on the type of digital content or data that the invention can handle though the techniques may be tailored to types of files with respect to user action against the content. One can appreciate that digital content is created in and can be converted to many different formats and may be in varying sizes, and users will have a variety of different uses for particular digital content or data.

In FIG. 5, user devices 511, such as computers, mobile phones and/or other computer devices, comprise a first operational layer. For the avoidance of doubt, portable or mobile devices can include a variety of computing devices including (a) portable media players, e.g., portable music players, such as MP3 players, walkmans, etc., (b) portable computing devices, such as laptops, personal digital assistants (“PDAs”), cell phones, portable email devices, thin clients, portable gaming devices, etc., (c) consumer electronic devices, such as TVs, DVD players, set top boxes, monitors, displays, etc., (d) public computing devices, such as kiosks, in-store music sampling devices, automated teller machines (ATMs), cash registers, etc., (e) navigation devices whether portable or installed in-vehicle and/or (f) non-conventional computing devices, such as kitchen appliances, motor vehicle controls (e.g., steering wheels), etc. Finally, while some embodiments are directed to systems and method for use in portable devices, as one of ordinary skill in the art can appreciate, the techniques are by no means limited to practice on portable devices, but may also apply to standalone computing devices, such as personal computers (“PCs”), server computers, gaming platforms (e.g., Xbox), mainframes, etc.

User devices 511 are communicatively coupled via networks 512 to a set of networked services 513 (which may be a centralized server, or distributed) which provide content storage, retrieval and configuration services. The server or services 513 include a keyword/command phrase parser 516 for receiving content and keywords from content owners and users for storage or retrieval of content in or from a keyword/content database 514, respectively, by the content management system. The server or services 513 also include a display/notification interface 517 for rendering or notifying designated recipients of content retrieved in accordance with content management techniques. User account data is also stored in storage 515, which includes configuration data and other user information as part of the user's account with the content management system. Storage techniques may also invariably be implemented across a plurality of storage components, such as databases or other storage, which may be co-located, or distributed, and of the same type of storage, or disparate types.

In operation, as described in more detail below, user devices operate to send keywords and command phrases to keyword/command phrase parser 16 for the retrieval of content for designated action based on the command phrases. The keywords are checked against the keyword/content database 514 in order to retrieve at least one set of content based on the commands of the command phrase(s) received by parser 516. Then, prior to taking action on the content, user account data in storage 515 may be further consulted to determine if there are any additional parameters (e.g., other filters on the content) that should be applied to the retrieved content based on configuration information stored for the user. Next, interface 517 takes any designated actions as specified by the commands of the command phrase(s) with respect to the resulting set(s) of content matching the user keywords and user configuration data. For instance, interface 517 may prepare the resulting set(s) of content for display on a particular user device known to have a certain type of display, or known to handle certain formats of content, i.e., the resulting content is readied for rendering on the device. Or, for another example, interface 517 may send notifications to a group of friends about the content and about certain actions (e.g., purchase) that may optionally be taken with respect to the content. Finally, the content and/or notifications are delivered to the appropriate recipient (e.g., the user in the case of a request for display of content, or the group of friends in the case of the notification example).

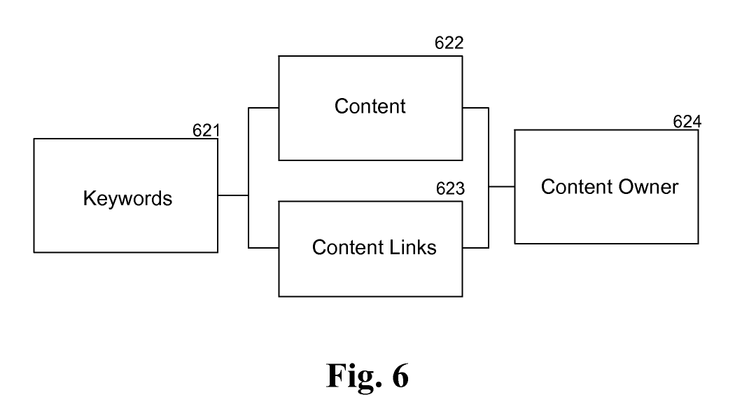

A number of tables are included in the database are depicted in FIG. 6. These tables are used to identify owners of digital content or data, to associate keywords with certain types of digital content or data and to assign certain available actions that might be available to take against the digital content or data. Tables are also used to manage the assignment of keywords to digital content or data to ensure that each set of digital content or data is assigned a unique keyword or keywords. Keywords 621 can be assigned to multiple content 622 and multiple content links 623. A content owner 624 can own multiple content 622 and multiple content links 623.

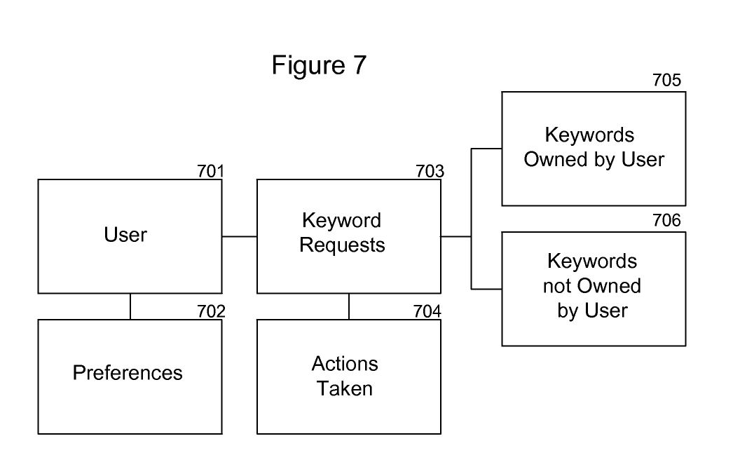

On the user side in FIG. 7, tables are used to identify a user 701 with the keyword requests 703, to store preferences 702 with respect to certain types of actions that may be taken against the digital content or data, and to record historical actions 704 actually taken by the user with respect to the digital content or data. From the user's perspective, their keyword requests 703 can be either of a keyword they own 705 or a keyword they do not own 706. The sum of 705 and 706 results in a Keyword table 621.

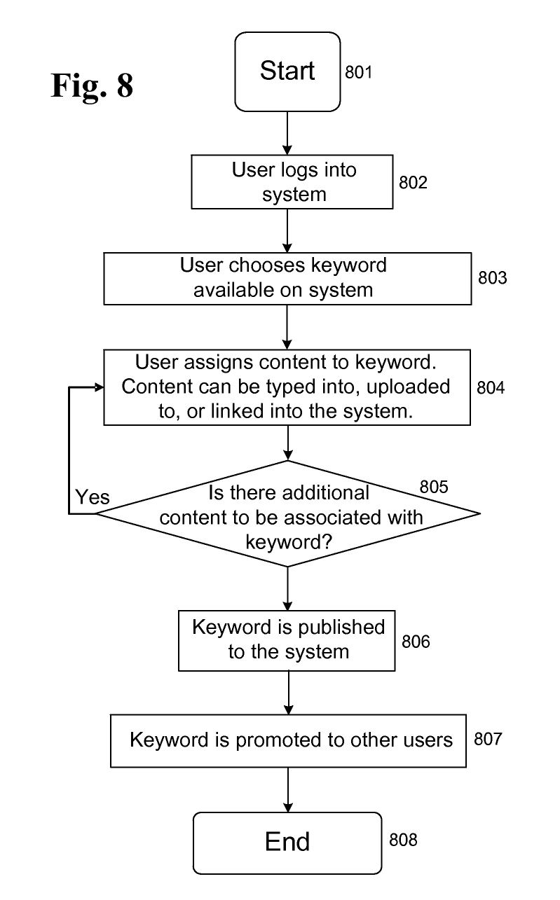

The owner of digital content or data can use the system to upload digital content or data, shown in FIG. 8. The user, starting at 801, then logs into the system at 802 and chooses a keyword that is currently available at 803. The user then assigns content to the keyword at 804 and determines if there is additional content to be associated with the keyword at 805. In one embodiment, the assignment of additional content that takes place at act 804 continues until the user is finished. The user then publishes the keyword at 806 to make it available for use. The keyword is then promoted to other users at 807, thereby ending the creation cycle of a keyword at 808. In addition, the owner of digital content or data may enable an integration point with the system that allows the system to retrieve the digital content or data from the owner on demand at the time it is required, and/or to take additional actions on demand. For instance, the system might signal a Web server under the control of the content owner to execute a script that the owner has designated, which script can execute any of a number of actions, for example real time queries, control over robotic systems, or registering a tally to be compared to the tallies recorded in response to other keywords. The owner may request the assignment of a keyword or keywords, or they will be assigned automatically, to the digital content or data. The database 514 depicted in FIG. 5 stores reference to the digital content, or interfaces to the digital or data, alongside tags representing the associated keyword or keywords. Digital content or data can be grouped together and may include different types of content or variations of the same content. Groups of digital content or data may share the same keyword or keywords.

By establishing a method and system for owners of digital content and data to connect the digital content or data to keywords, a better means of locating digital content and data is realized. There are many circumstances in which it may be beneficial for a person to obtain digital content without searching for the content, disclosing one's identity to a third or being compelled to provide a unique place of delivery and receipt such as a physical mailing address, email or fax number. The ability for a user to request digital content with keywords meets the needs and interests of users because they can enable access to the content they want when they want it in a simple and convenient way, typically via a mobile device. It also helps meet the needs of content owners, commerce providers and other organizations looking to distribute digital content or data, or have actions taken against such digital content or data, because they know the persons requesting access are genuinely interested.

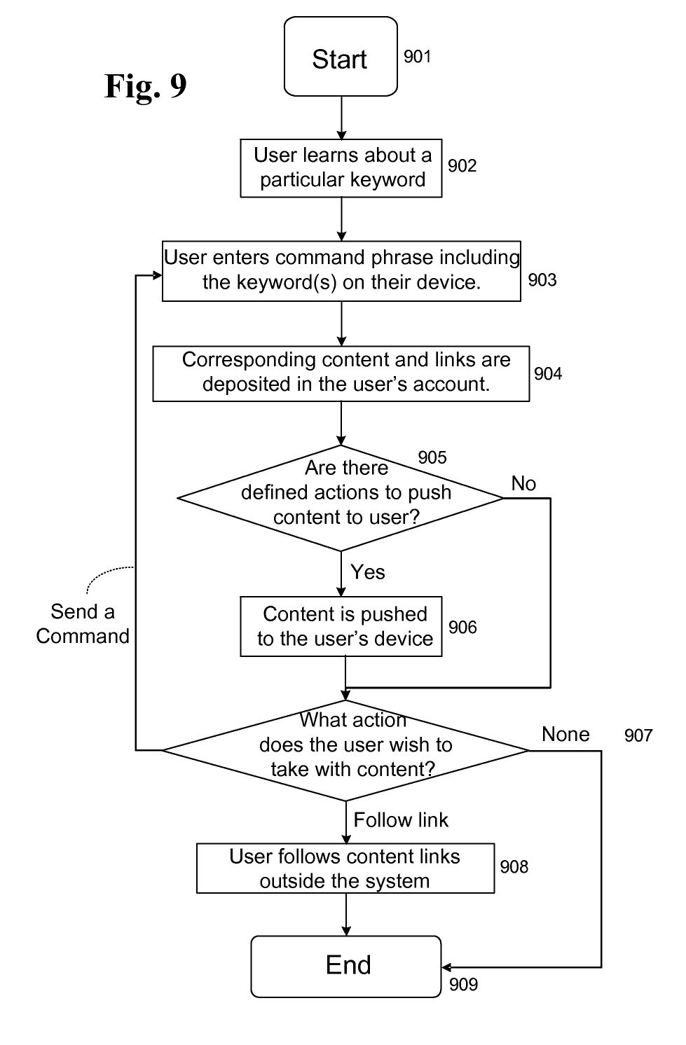

A typical user experience, shown in FIG. 9, starts with the mobile terminal at 901, although any computer may encompass the initiating source for delivery of the keywords by the user. A user will know to or be instructed to send specific keywords as a message to the server at 902. Once the user enters a command phrase, including a keyword, on their device at 903, the corresponding content and links are deposited into the user's account at 904. If there are predefined actions to push the content to the user at 905 then that content is pushed to the user's device at 906. The user decides what action to take with the content and links deposited in their account at 907 by either repeating the keyword and command phrase step returning to 903, taking no action thus ending the steps at 909, or following a content link given to them which will take them outside the system at 908.

In a non-limiting, embodiment, the system is supported by an SMS mobile messaging platform that integrates with the multiple platforms of the cellular companies (or, for those cellular companies with an alternate preferred means of text messaging, to their equivalent of SMS), as well as a content management system. In this case, the request server receives an SMS (or equivalent) containing the keyword from a user and looks up the digital content or data that the user is requesting in the database. The request server is reached through the use of an instant messaging (IM) system wherein the request server as a machine is reached as part of the IM's buddy list. In such an embodiment, the request server would appear as a buddy on the user's IM interface, which means that the user could initiate a text message conversation with the request server using the IM's existing capabilities. The user would send the keywords as a text message. In yet another embodiment, the user could use an entry field on a web based application that is directly connected to the system. In all cases, the system would realize the identity of the user, which information would be available to the system based on the method of communication selected.

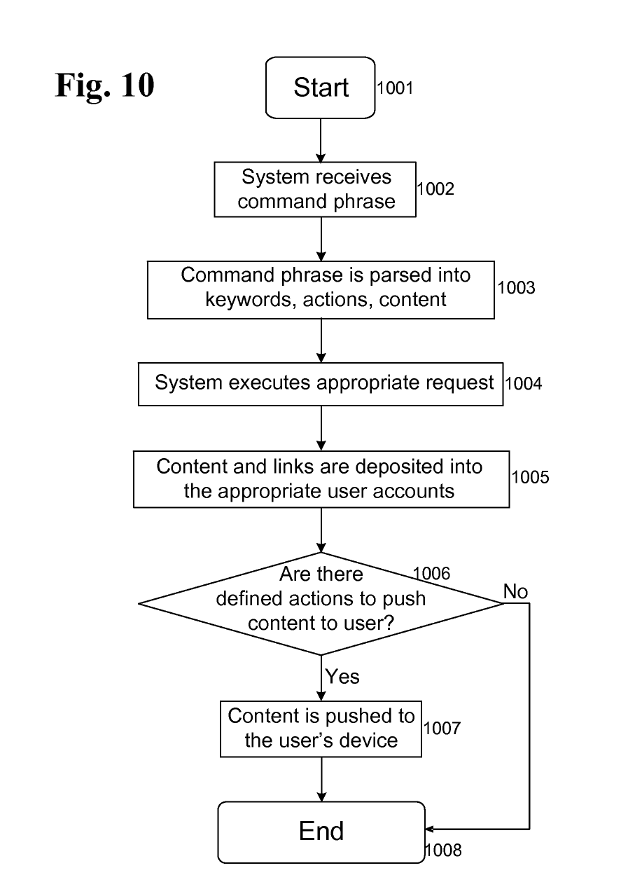

FIG. 10 shows the system flow of the keyword/content processing. The system begins at 1001 and then receives a command phrase at 1002. This command phrase is parsed into keywords, actions, and content at 1003 by the system. The system then executes the appropriate request at 1004 and content and/or link(s) are deposited into the appropriate user accounts at 1005. If there are defined actions to push content to users at 1006, then the content is pushed to the user(s)' device at 1007; if not, the system process ends at 1008.

Once the digital content or data is identified by its keywords, it can be presented to the user on a web-based application enabled by the system, which may be accessible via generally available web browsers on either personal computers or mobile devices. The manner in which digital content or data is displayed to the user is controlled by preferences of the owner of the digital content or data, the type of digital content or data, and the capabilities of the system. For example, a hyperlink to a url may appears as a hyperlink with brief summary information associated with the hyperlink appearing underneath. An audio file may appear only as a title of the audio file. A video may appear as a single digital image of one of the frames of the video with no title or description.

Depending on the type of digital content or data stored or integrated with system, certain actions may be available to take with respect to the content. For example, a user who is presented with the content by the system may be able to forward the content received directly to an email account or some other system. Sometimes a user may want to have the requested digital content or data delivered directly back to a mobile terminal. Other times, the user may want to have the digital content or data viewable in a web browser, or the original software application in which the digital content or data was meant to be viewed.

A user may also predefine a preference as to what to do with the digital content or data so that the system will take action with the digital content or data immediately. For example, if a user were requesting audio files from the same digital content owner repeatedly, and each time the user used the capabilities of the system to export the file to another system, the user may instead configure the system to automatically forward the audio file to another system or software application.

Digital content or data may also be configured by the system for other actions by the user. For example, the seller of shoes may enable a user to use the keyword “shoes” to deposit a hyperlink to the seller's website in the user's account for the user to obtain additional information on the particular shoes. In addition to the additional information, however, the system may also enable the user to buy the shoes without leaving the web based application, the system having configured the digital content or data to enable the ability to conduct an e-commerce transaction.

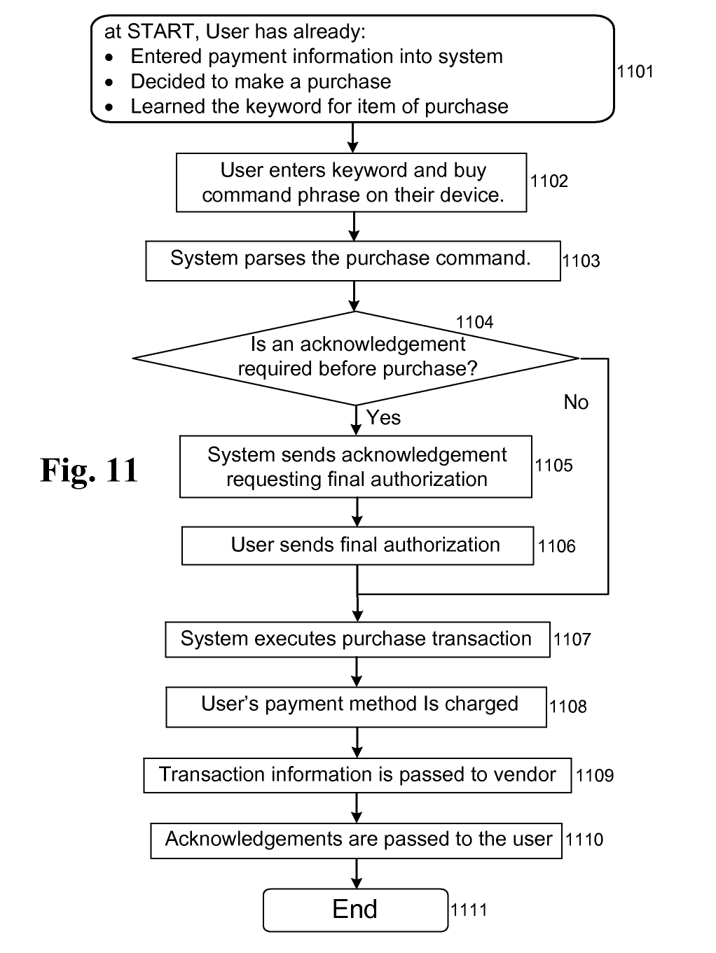

The system also supports actions that can be specified at the time of submitting the keyword, to have the system process those actions directly. One category of action is the purchase of an item represented by a keyword. FIG. 11 shows the action flow of such a scenario. Prior to making a purchase, the user has entered their personal payment information and preferences into the system, decided to make a purchase, and knows the keyword and command phrase for the item of interest at 1101. When the user wants to purchase an item directly using the system, the user will enter the keyword and the buy command as one command phrase into the system at 1102, the system parses the purchase request at 1103 and determines if an acknowledgement is required in order to make the purchase at 1104. If so, then the system responds with a confirmation request at 1105, and when the user acknowledges the confirmation at 1106, the system acts as a purchasing agent by executing the purchase transaction at 1107, charging the user's payment method at 1108, passing the purchase and payment information securely along to the vendor at 1109, returning whatever acknowledgement or receipt is necessary to the user at 1110, thus completing the process at 1111. If no acknowledgement is required at 1104, then the system jumps to execute the transaction at 1107.

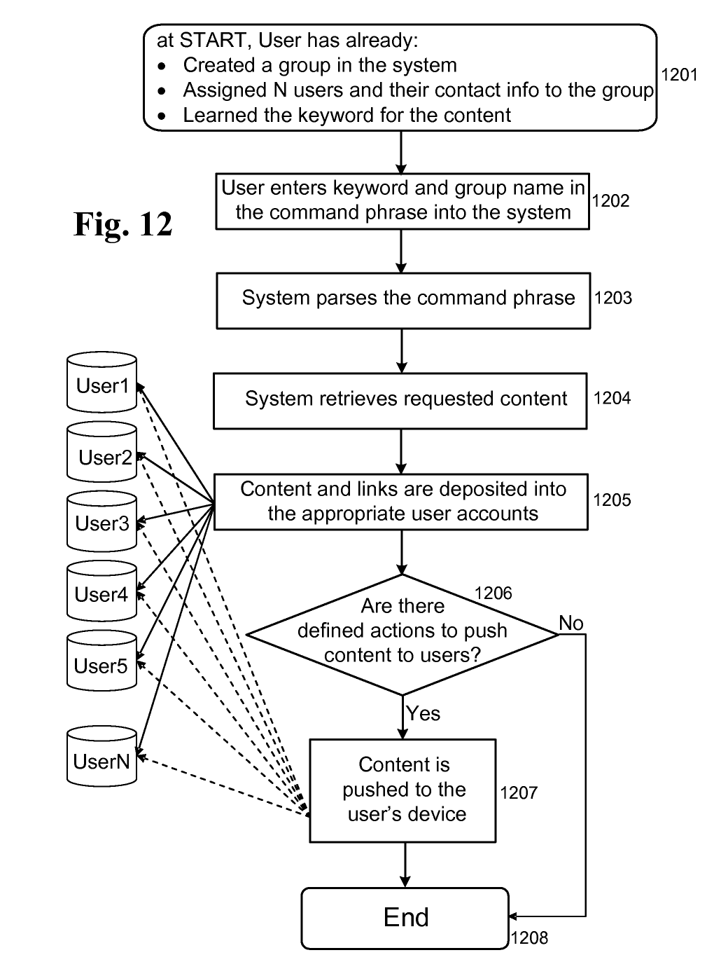

Another use of the system is in the quick and easy dissemination of content represented by keywords to another recipient or multiple other recipients. FIG. 12 shows this scenario. In one embodiment, the user can append the keyword with a short command followed by another person's phone number, as a single command, and the system will create an account for the other person, notify the person of the account's existence and associate the content related to the keyword with the other person's account. Prior to sending a multiple-recipient message, the user has defined a group name, associated a list of members and their contact information with the group name, and learned the keyword for whatever content they wish to share at 1201. When a user wants to pass information to multiple recipients, the user will enter the keyword and the group name in one command phrase into the system at 1202. The system then parses the command phrase at 1203 and retrieves the content associated with the keyword at 1204 and automatically deposits the content response into the accounts or devices of all the members of the group at 1205. If there are defined actions to push content to the users at 1206, then the content is pushed to the device of each member of the group at 1207; if not, then the process ends at 1208.

By enabling a system that allows different groups to tag and manage digital content or data in a way that make it easier for other people to access, particularly in a mobile oriented world, time is saved, providing an improved means for privacy and reduction of costs for the parties involved. The establishment of a central system (‘central’ from the standpoint of the users and content owners, though the services may be distributed and need not be a central set of servers) to manage and configure the requested digital content or data allows the user to rely on a single destination to manage multiple requests of multiple types of content from multiple content owners.

### Exemplary Network and Operating Environments

The following description sets forth some exemplary networks and non-limiting operating environments for the systems and methods for gift text messaging of the present invention. The below-described operating environments should be considered non-exhaustive, however, and thus the below-described network architectures merely show how the services of the present invention may be incorporated into some exemplary existing network structures and architectures. One can appreciate, however, that the invention may be incorporated into now existing or future alternative architectures for communication networks as well, and to systems that encompass or integrate a plurality of disparate communication networks.

The global system for mobile communication (“GSM”) is one of the most widely utilized wireless access systems in today's fast growing communication systems. GSM provides circuit-switched data services to subscribers, such as mobile telephone or computer users. General Packet Radio Service (“GPRS”), which is an extension to GSM technology, introduces packet switching to GSM networks. GPRS uses a packet-based wireless communication technology to transfer high and low speed data and signaling in an efficient manner. GPRS optimizes the use of network and radio resources, thus enabling the cost effective and efficient use of GSM network resources for packet mode applications.

As one of ordinary skill in the art can appreciate, the exemplary GSM/GPRS environment and services described herein can also be extended to 3G services, such as Universal Mobile Telephone System (“UMTS”), Frequency Division Duplexing (“FDD”) and Time Division Duplexing (“TDD”), High Speed Packet Data Access (“HSPDA”), cdma2000 1x Evolution Data Optimized (“EVDO”), Code Division Multiple Access-2000 (“cdma2000 3x”), Time Division Synchronous Code Division Multiple Access (“TD-SCDMA”), Wideband Code Division Multiple Access (“WCDMA”), Enhanced Data GSM Environment (“EDGE”), International Mobile Telecommunications-2000 (“IMT-2000”), Digital Enhanced Cordless Telecommunications (“DECT”), etc., as well as to other network services that shall become available in time. In this regard, the techniques of the invention may be applied independently of the method of data transport, and do not depend on any particular network architecture, or underlying protocols.

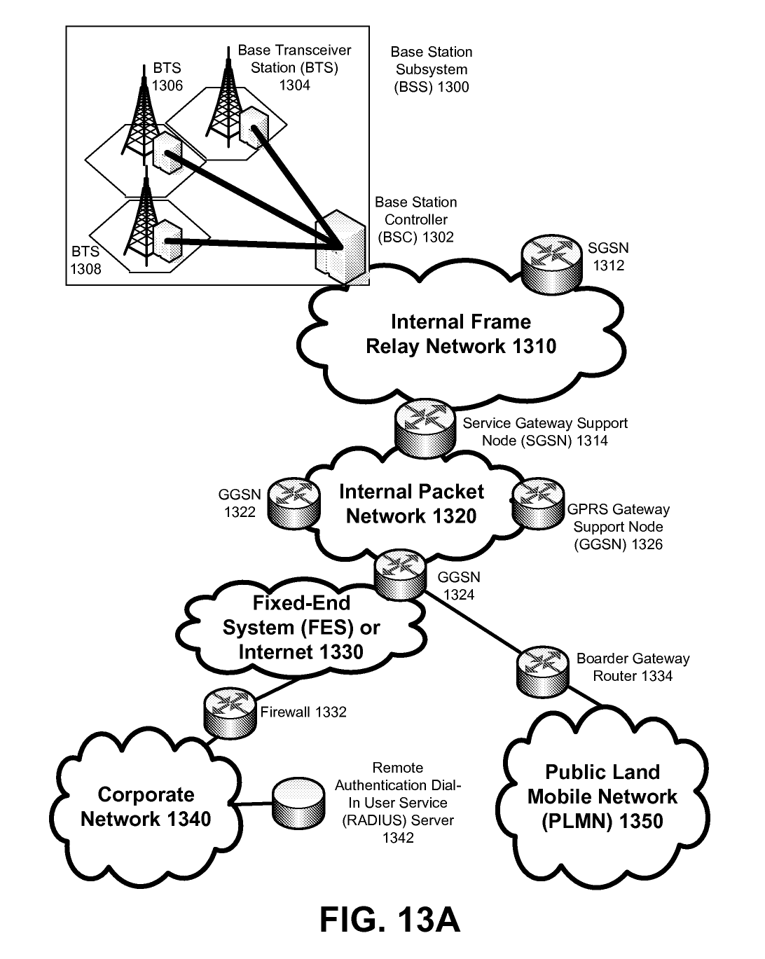

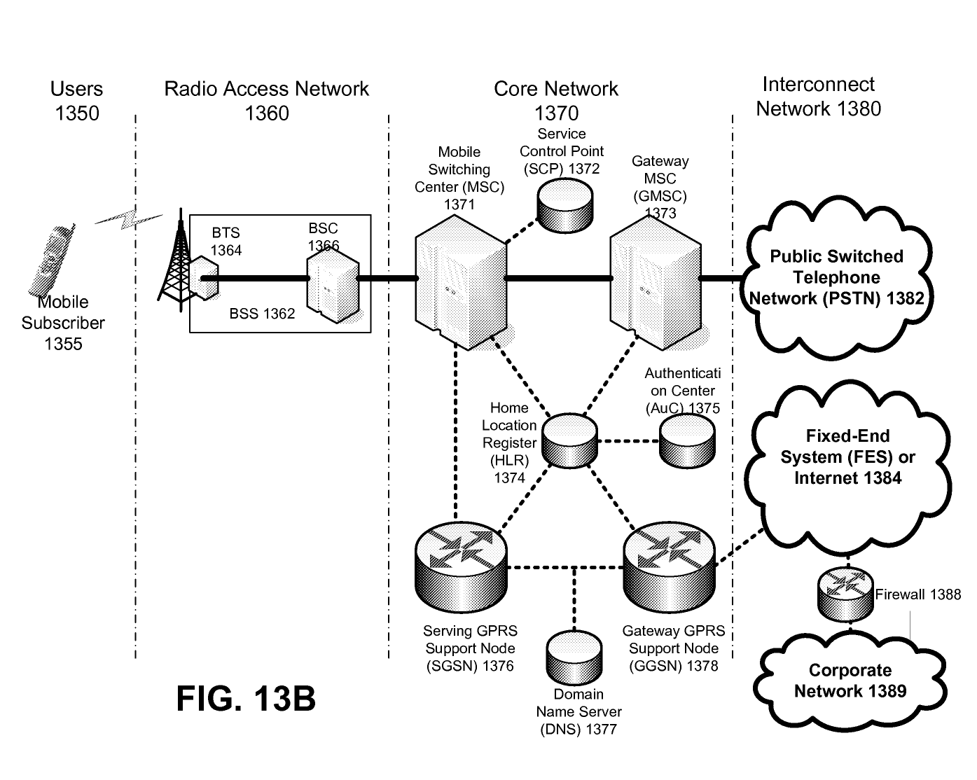

FIG. 13A depicts an overall block diagram of an exemplary packet-based mobile cellular network environment, such as a GPRS network, in which the invention may be practiced. In such an environment, there are a plurality of Base Station Subsystems (“BSS”) 1300 (only one is shown), each of which comprises a Base Station Controller (“BSC”) 1302 serving a plurality of Base Transceiver Stations (“BTS”) such as BTSs 1304, 1306, and 1308. BTSs 1304, 1306, 1308, etc. are the access points where users of packet-based mobile devices become connected to the wireless network. In exemplary fashion, the packet traffic originating from user devices is transported over the air interface to a BTS 1308, and from the BTS 1308 to the BSC 1302. Base station subsystems, such as BSS 1300, are a part of internal frame relay network 1310 that may include Service GPRS Support Nodes (“SGSN”) such as SGSN 1312 and 1314. Each SGSN is in turn connected to an internal packet network 1320 through which a SGSN 1312, 1314, etc. can route data packets to and from a plurality of gateway GPRS support nodes (GGSN) 1322, 1324, 1326, etc. As illustrated, SGSN 1314 and GGSNs 1322, 1324, and 1326 are part of internal packet network 1320. Gateway GPRS serving nodes 1322, 1324 and 1326 mainly provide an interface to external Internet Protocol (“IP”) networks such as Public Land Mobile Network (“PLMN”) 1350, corporate intranets 1340, or Fixed-End System (“FES”) or the public Internet 1330. As illustrated, subscriber corporate network 1340 may be connected to GGSN 1324 via firewall 1332; and PLMN 1350 is connected to GGSN 1324 via boarder gateway router 1334. The Remote Authentication Dial-In User Service (“RADIUS”) server 1342 may be used for caller authentication when a user of a mobile cellular device calls corporate network 1340.

Generally, there can be four different cell sizes in a GSM network—macro, micro, pico and umbrella cells. The coverage area of each cell is different in different environments. Macro cells can be regarded as cells where the base station antenna is installed in a mast or a building above average roof top level. Micro cells are cells whose antenna height is under average roof top level; they are typically used in urban areas. Pico cells are small cells having a diameter is a few dozen meters; they are mainly used indoors. On the other hand, umbrella cells are used to cover shadowed regions of smaller cells and fill in gaps in coverage between those cells.

FIG. 13B illustrates the architecture of a typical GPRS network as segmented into four groups: users 1350, radio access network 1360, core network 1370, and interconnect network 1380. Users 1350 comprise a plurality of end users (though only mobile subscriber 1355 is shown in FIG. 13B). Radio access network 1360 comprises a plurality of base station subsystems such as BSSs 1362, which include BTSs 1364 and BSCs 1366. Core network 1370 comprises a host of various network elements. As illustrated here, core network 1370 may comprise Mobile Switching Center (“MSC”) 1371, Service Control Point (“SCP”) 1372, gateway MSC 1373, SGSN 1376, Home Location Register (“HLR”) 1374, Authentication Center (“AuC”) 1375, Domain Name Server (“DNS”) 1377, and GGSN 1378. Interconnect network 1380 also comprises a host of various networks and other network elements. As illustrated in FIG. 13B, interconnect network 1380 comprises Public Switched Telephone Network (“PSTN”) 1382, Fixed-End System (“FES”) or Internet 1384, firewall 1388, and Corporate Network 1389.

A mobile switching center can be connected to a large number of base station controllers. At MSC 1371, for instance, depending on the type of traffic, the traffic may be separated in that voice may be sent to Public Switched Telephone Network (“PSTN”) 1382 through Gateway MSC (“GMSC”) 1373, and/or data may be sent to SGSN 1376, which then sends the data traffic to GGSN 1378 for further forwarding.

When MSC 1371 receives call traffic, for example, from BSC 1366, it sends a query to a database hosted by SCP 1372. The SCP 1372 processes the request and issues a response to MSC 1371 so that it may continue call processing as appropriate.

The HLR 1374 is a centralized database for users to register to the GPRS network. HLR 1374 stores static information about the subscribers such as the International Mobile Subscriber Identity (“IMSI”), subscribed services, and a key for authenticating the subscriber. HLR 1374 also stores dynamic subscriber information such as the current location of the mobile subscriber. Associated with HLR 1374 is AuC 1375. AuC 1375 is a database that contains the algorithms for authenticating subscribers and includes the associated keys for encryption to safeguard the user input for authentication.

In the following, depending on context, the term “mobile subscriber” sometimes refers either to the end user and sometimes to the actual portable device used by an end user of the mobile cellular service. When a mobile subscriber turns on his or her mobile device, the mobile device goes through an attach process by which the mobile device attaches to an SGSN of the GPRS network. In FIG. 13B, when mobile subscriber 1355 initiates the attach process by turning on the network capabilities of the mobile device, an attach request is sent by mobile subscriber 1355 to SGSN 1376. The SGSN 1376 queries another SGSN, to which mobile subscriber 1355 was attached before, for the identity of mobile subscriber 1355. Upon receiving the identity of mobile subscriber 1355 from the other SGSN, SGSN 1376 requests more information from mobile subscriber 1355. This information is used to authenticate mobile subscriber 1355 to SGSN 1376 by HLR 1374. Once verified, SGSN 1376 sends a location update to HLR 1374 indicating the change of location to a new SGSN, in this case SGSN 1376. HLR 1374 notifies the old SGSN, to which mobile subscriber 1355 was attached before, to cancel the location process for mobile subscriber 1355. HLR 1374 then notifies SGSN 1376 that the location update has been performed. At this time, SGSN 1376 sends an Attach Accept message to mobile subscriber 1355, which in turn sends an Attach Complete message to SGSN 1376.

After attaching itself with the network, mobile subscriber 1355 then goes through an authentication process. In the authentication process, SGSN 1376 sends the authentication information to HLR 1374, which sends information back to SGSN 1376 based on the user profile that was part of the user's initial setup. The SGSN 1376 then sends a request for authentication and ciphering to mobile subscriber 1355. The mobile subscriber 1355 uses an algorithm to send the user identification (ID) and password to SGSN 1376. The SGSN 1376 uses the same algorithm and compares the result. If a match occurs, SGSN 1376 authenticates mobile subscriber 1355.

Next, the mobile subscriber 1355 establishes a user session with the destination network, corporate network 1389, by going through a Packet Data Protocol (“PDP”) activation process. Briefly, in the process, mobile subscriber 1355 requests access to the Access Point Name (“APN”), for example, UPS.com (e.g., which can be corporate network 1379 in FIG. 13B) and SGSN 1376 receives the activation request from mobile subscriber 1355. SGSN 1376 then initiates a Domain Name Service (“DNS”) query to learn which GGSN node has access to the UPS.com APN. The DNS query is sent to the DNS server within the core network 1370, such as DNS 1377, which is provisioned to map to one or more GGSN nodes in the core network 1370. Based on the APN, the mapped GGSN 1378 can access the requested corporate network 1379. The SGSN 1376 then sends to GGSN 1378 a Create Packet Data Protocol (“PDP”) Context Request message that contains necessary information. The GGSN 1378 sends a Create PDP Context Response message to SGSN 1376, which then sends an Activate PDP Context Accept message to mobile subscriber 1355.

Once activated, data packets of the call made by mobile subscriber 1355 can then go through radio access network 1360, core network 1370, and interconnect network 1380, in particular fixed-end system or Internet 1384 and firewall 1388, to reach corporate network 1389.

Thus, network elements that may implicate the functionality of the systems and methods for gift text messaging in accordance with the invention may include but are not limited to Gateway GPRS Support Node tables, Fixed End System router tables, firewall systems, VPN tunnels, and any number of other network elements as required by the particular digital network.

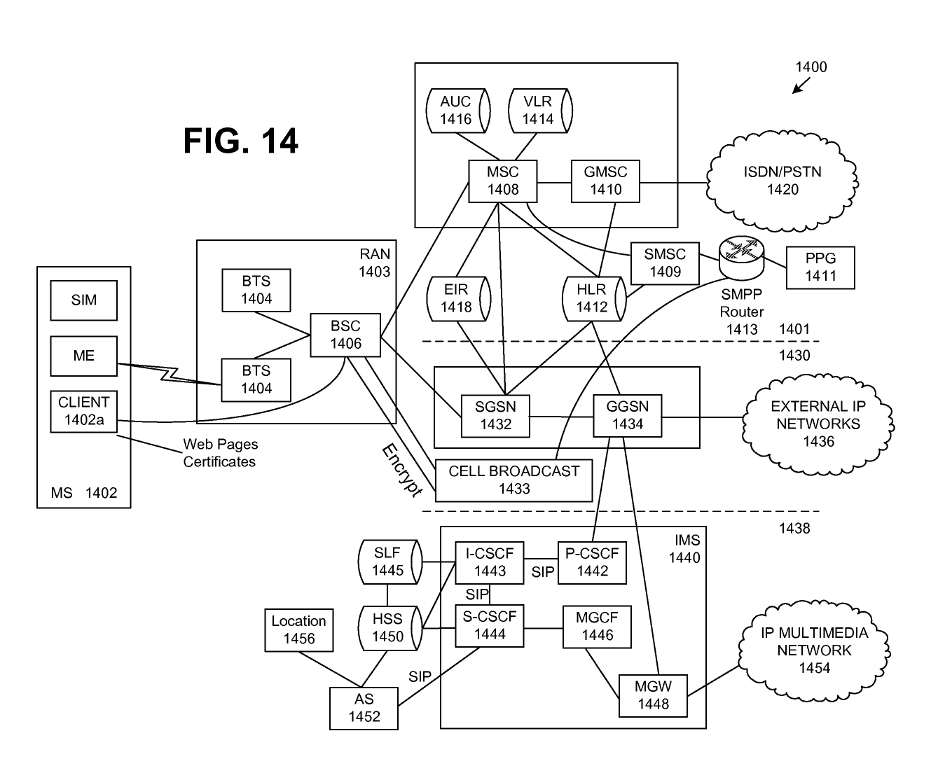

FIG. 14 shows yet another exemplary block diagram view of a GSM/GPRS/IP multimedia network architecture 1400 in which the systems and methods for gift text messaging of the present invention may be incorporated. As illustrated, architecture 1400 of FIG. 14 includes a GSM core network 1401, a GPRS network 1430 and an IP multimedia network 1438. The GSM core network 1401 includes a Mobile Station (MS) 1402, at least one Base Transceiver Station (BTS) 1404 and a Base Station Controller (BSC) 1406. The MS 1402 is physical equipment or Mobile Equipment (ME), such as a mobile phone or a laptop computer that is used by mobile subscribers, with a Subscriber identity Module (SIM). The SIM includes an International Mobile Subscriber Identity (IMSI), which is a unique identifier of a subscriber. The BTS 1404 is physical equipment, such as a radio tower, that enables a radio interface to communicate with the MS. Each BTS may serve more than one MS. The BSC 1406 manages radio resources, including the BTS. The BSC may be connected to several BTSs. The BSC and BTS components, in combination, are generally referred to as a base station (BSS) or radio access network (RAN) 1403. The GSM core network 1401 also includes a Mobile Switching Center (MSC) 1408, a Gateway Mobile Switching Center (GMSC) 1410, a Home Location Register (HLR) 1412, Visitor Location Register (VLR) 1414, an Authentication Center (AuC) 1418, and an Equipment Identity Register (EIR) 1416. The MSC 1408 performs a switching function for the network. The MSC also performs other functions, such as registration, authentication, location updating, handovers, and call routing. The GMSC 1410 provides a gateway between the GSM network and other networks, such as an Integrated Services Digital Network (ISDN) or Public Switched Telephone Networks (PSTNs) 1420. In other words, the GMSC 1410 provides interworking functionality with external networks.

The HLR 1412 is a database that contains administrative information regarding each subscriber registered in a corresponding GSM network. The HLR 1412 also contains the current location of each MS. The VLR 1414 is a database that contains selected administrative information from the HLR 1412. The VLR contains information necessary for call control and provision of subscribed services for each MS currently located in a geographical area controlled by the VLR. The HLR 1412 and the VLR 1414, together with the MSC 1408, provide the call routing and roaming capabilities of GSM. The AuC 1416 provides the parameters needed for authentication and encryption functions. Such parameters allow verification of a subscriber's identity. The EIR 1418 stores security-sensitive information about the mobile equipment.

A Short Message Service Center (SMSC) 1409 allows one-to-one Short Message Service (SMS) messages to be sent to/from the MS 1402. A Push Proxy Gateway (PPG) 1411 is used to “push” (i.e., send without a synchronous request) content to the MS 1402. The PPG 1411 acts as a proxy between wired and wireless networks to facilitate pushing of data to the MS 1402. A Short Message Peer to Peer (SMPP) protocol router 1413 is provided to convert SMS-based SMPP messages to cell broadcast messages. SMPP is a protocol for exchanging SMS messages between SMS peer entities such as short message service centers. It is often used to allow third parties, e.g., content suppliers such as news organizations, to submit bulk messages.

To gain access to GSM services, such as speech, data, and short message service (SMS), the MS first registers with the network to indicate its current location by performing a location update and IMSI attach procedure. The MS 1402 sends a location update including its current location information to the MSC/VLR, via the BTS 1404 and the BSC 1406. The location information is then sent to the MS's HLR. The HLR is updated with the location information received from the MSC/VLR. The location update also is performed when the MS moves to a new location area. Typically, the location update is periodically performed to update the database as location updating events occur.

The GPRS network 1430 is logically implemented on the GSM core network architecture by introducing two packet-switching network nodes, a serving GPRS support node (SGSN) 1432, a cell broadcast and a Gateway GPRS support node (GGSN) 1434. The SGSN 1432 is at the same hierarchical level as the MSC 1408 in the GSM network. The SGSN controls the connection between the GPRS network and the MS 1402. The SGSN also keeps track of individual MS's locations and security functions and access controls.

A Cell Broadcast Center (CBC) 1433 communicates cell broadcast messages that are typically delivered to multiple users in a specified area. Cell Broadcast is one-to-many geographically focused service. It enables messages to be communicated to multiple mobile phone customers who are located within a given part of its network coverage area at the time the message is broadcast.

The GGSN 1434 provides a gateway between the GPRS network and a public packet network (PDN) or other IP networks 1436. That is, the GGSN provides interworking functionality with external networks, and sets up a logical link to the MS through the SGSN. When packet-switched data leaves the GPRS network, it is transferred to an external TCP-IP network 1436, such as an X.25 network or the Internet. In order to access GPRS services, the MS first attaches itself to the GPRS network by performing an attach procedure. The MS then activates a packet data protocol (PDP) context, thus activating a packet communication session between the MS, the SGSN, and the GGSN.

In a GSM/GPRS network, GPRS services and GSM services can be used in parallel. The MS can operate in one three classes: class A, class B, and class C. A class A MS can attach to the network for both GPRS services and GSM services simultaneously. A class A MS also supports simultaneous operation of GPRS services and GSM services. For example, class A mobiles can receive GSM voice/data/SMS calls and GPRS data calls at the same time.

A class B MS can attach to the network for both GPRS services and GSM services simultaneously. However, a class B MS does not support simultaneous operation of the GPRS services and GSM services. That is, a class B MS can only use one of the two services at a given time.

A class C MS can attach for only one of the GPRS services and GSM services at a time. Simultaneous attachment and operation of GPRS services and GSM services is not possible with a class C MS.

A GPRS network 1430 can be designed to operate in three network operation modes (NOM1, NOM2 and NOM3). A network operation mode of a GPRS network is indicated by a parameter in system information messages transmitted within a cell. The system information messages dictates a MS where to listen for paging messages and how signal towards the network. The network operation mode represents the capabilities of the GPRS network. In a NOM1 network, a MS can receive pages from a circuit switched domain (voice call) when engaged in a data call. The MS can suspend the data call or take both simultaneously, depending on the ability of the MS. In a NOM2 network, a MS may not received pages from a circuit switched domain when engaged in a data call, since the MS is receiving data and is not listening to a paging channel In a NOM3 network, a MS can monitor pages for a circuit switched network while received data and vice versa.

The IP multimedia network 1438 was introduced with 3GPP Release 5, and includes an IP multimedia subsystem (IMS) 1440 to provide rich multimedia services to end users. A representative set of the network entities within the IMS 1440 are a call/session control function (CSCF), a media gateway control function (MGCF) 1446, a media gateway (MGW) 1448, and a master subscriber database, called a home subscriber server (HSS) 1450. The HSS 1450 may be common to the GSM network 1401, the GPRS network 1430 as well as the IP multimedia network 1438.

The IP multimedia system 1440 is built around the call/session control function, of which there are three types: an interrogating CSCF (I-CSCF) 1443, a proxy CSCF (P-CSCF) 1442, and a serving CSCF (S-CSCF) 1444. The P-CSCF 1442 is the MS's first point of contact with the IMS 1440. The P-CSCF 1442 forwards session initiation protocol (SIP) messages received from the MS to an SIP server in a home network (and vice versa) of the MS. The P-CSCF 1442 may also modify an outgoing request according to a set of rules defined by the network operator (for example, address analysis and potential modification).

The I-CSCF 1443, forms an entrance to a home network and hides the inner topology of the home network from other networks and provides flexibility for selecting an S-CSCF. The I-CSCF 1443 may contact a subscriber location function (SLF) 1445 to determine which HSS 1450 to use for the particular subscriber, if multiple HSS's 1450 are present. The S-CSCF 1444 performs the session control services for the MS 1402. This includes routing originating sessions to external networks and routing terminating sessions to visited networks. The S-CSCF 1444 also decides whether an application server (AS) 1452 is required to receive information on an incoming SIP session request to ensure appropriate service handling. This decision is based on information received from the HSS 1450 (or other sources, such as an application server 1452). The AS 1452 also communicates to a location server 1456 (e.g., a Gateway Mobile Location Center (GMLC)) that provides a position (e.g., latitude/longitude coordinates) of the MS 1402.

The HSS 1450 contains a subscriber profile and keeps track of which core network node is currently handling the subscriber. It also supports subscriber authentication and authorization functions (AAA). In networks with more than one HSS 1450, a subscriber location function provides information on the HSS 1450 that contains the profile of a given subscriber.

The MGCF 1446 provides interworking functionality between SIP session control signaling from the IMS 1440 and ISUP/BICC call control signaling from the external GSTN networks (not shown). It also controls the media gateway (MGW) 1448 that provides user-plane interworking functionality (e.g., converting between AMR- and PCM-coded voice). The MGW 1448 also communicates with other IP multimedia networks 1454.

Push to Talk over Cellular (PoC) capable mobile phones register with the wireless network when the phones are in a predefined area (e.g., job site, etc.). When the mobile phones leave the area, they register with the network in their new location as being outside the predefined area. This registration, however, does not indicate the actual physical location of the mobile phones.

There are multiple ways of implementing the present invention, e.g., an appropriate API, tool kit, driver code, operating system, control, standalone or downloadable software object, etc., which enable applications and services to use the gift text messaging user interfaces and/or processes of the invention. The invention contemplates the use of the invention from the standpoint of an API (or other software object), as well as from a software or hardware object that carries out main functionality of the automatic gift text messaging programs and/or processes in accordance with the invention. Thus, various implementations of the invention described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned above, while exemplary embodiments of the present invention have been described in connection with various computing devices and network architectures, the underlying concepts may be applied to any computing device or network architecture for a financial institution. For instance, the gift text messaging applications and/or processes of the invention may be applied to the operating system of a computing device, provided as a separate object on the device, as part of another object, as a reusable control, as a downloadable object from a server, as a “middle man” between a device or object and the network, as a distributed object, as hardware, in memory, a combination of any of the foregoing, etc. While exemplary programming languages, names and examples are chosen herein as representative of various choices, these languages, names and examples are not intended to be limiting. One of ordinary skill in the art will appreciate that there are numerous ways of providing object code and nomenclature that achieves the same, similar or equivalent functionality achieved by the various embodiments of the invention.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the gift text messaging programs and/or processes of the present invention, e.g., through the use of a data processing API, reusable controls, or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, etc., the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) where used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described sura, methodologies that may be implemented in accordance with the disclosed subject matter will be better appreciated with reference to the flowcharts of figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary network environments of the invention are described in the context of a networked environment, such as a peer to peer networked environment, one skilled in the art will recognize that the present invention is not limited thereto, and that the methods, as described in the present application may apply to any computing device or environment, such as a gaming console, handheld computer, portable computer, etc., whether wired or wireless, and may be applied to any number of such computing devices connected via a communications network, and interacting across the network.

Furthermore, it should be emphasized that a variety of computer platforms, including handheld device operating systems and other application specific operating systems are contemplated, especially as the number of wireless networked devices continues to proliferate. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A method for electronic gifting, comprising:
receiving, by a service, a designation of a gift recipient and receiving at least one designation of a gift offered in a set of gifts displayed by a user interface component of the service; and
automatically generating a message based on the at least one designation including automatically generating a message having a unique identifier that corresponds to a product or service of an enabling entity that enables the product or service; and
automatically transmitting the message to the gift recipient.

2. The method of claim 1, further comprising:
associating the gift recipient with at least one user keyword maintained by the service.

3. The method of claim 1, further comprising:
receiving and storing, by the service, a secret from the gift recipient.

4. The method of claim 3, wherein the generating includes automatically encrypting the unique identifier with the secret provided by the gift recipient.

5. The method of claim 3, wherein the generating includes automatically hashing the unique identifier using the secret provided by the gift recipient.

6. The method of claim 1, further comprising:
analyzing data in a data store to determine the set of gifts to display in the user interface component of the service.

7. The method of claim 6, wherein the analyzing includes analyzing information relating to the user of the service.

8. The method of claim 6, wherein the analyzing includes analyzing information relating to the gift recipient.

9. The method of claim 6, wherein the analyzing includes analyzing an external source of information.

10. The method of claim 9, wherein the analyzing includes analyzing a GPS location of a mobile device of the gift recipient.

11. The method of claim 6, wherein the analyzing includes analyzing a context of the service.

12. The method of claim 1, wherein the generating includes automatically generating a short message service (SMS) message.

13. The method of claim 1, wherein the generating includes automatically generating a multimedia messaging service (MMS) message.

14. The method of claim 1, wherein the generating includes automatically generating a wireless application protocol (WAP) message.

15. The method of claim 1, further comprising, pre-associating a mobile number of the gift recipient with the gift recipient, wherein the transmitting includes automatically transmitting the message to the gift recipient's mobile number without input by the gifter.

16. The method of claim 1, wherein the receiving at least one designation of a gift includes receiving the at least one designation by a web site.

17. The method of claim 1, wherein the receiving at least one designation of a gift includes receiving the at least one designation by a mobile device application.

18. A method for making a gift to a networked portable device with a short messaging service (SMS), multimedia messaging service (MMS) or wireless application protocol (WAP) message communicated via a network, comprising:
entering setup information, wherein the setup information includes any one or more of (a) payment information or (b) at least one gift keyword for at least one item related to a gifting decision;
transmitting the setup information to the service;
entering of gift selection information via a user interface of the networked portable device, wherein the gift selection information includes at least one gift keyword of said at least one gift keyword and a command that initiates gifting of at least one item of said at least one item to a third party; and
transmitting the gift selection information to the service, whereby the service automatically generates at least one SMS message, at least one MMS message, or at least one WAP message including at least one unique code representing the at least one item of said at least one item.

19. The method of claim 18, further comprising:
performing any purchasing required for the at least one unique code at least based on the setup information.

20. The method of claim 18, whereby the service automatically initiates a charge according to the payment information.

21. The method of claim 18, further comprising:
storing transaction information, wherein the transaction information includes a record of the gifting of the at least one item of said at least one item.

22. A method for electronic gifting, comprising:
receiving, by a host computing environment, one or more of (a) gifter information about a potential set of gifts, (b) giftee information about a potential set of gifts, (c) context of the host computing environment or (d) external information relating to a potential set of gifts;
recommending, by the host computing environment, a set of gifts to a gifter based on analysis of any one or more of the gifter information, giftee information, context, or external information;
receiving a selection of a gift from the set of gifts from the gifter;
electronically transacting for a value associated with the gift;
automatically generating a gift message based on the selected gift including automatically generating a gift message having a unique product or service code that corresponds to a product or service of an enabling entity that enables the product or service; and
automatically transmitting the gift message to pre-stored mobile number associated with a mobile device of a designated gift recipient.

23. The method of claim 22, wherein the transacting includes automatically electronically transacting for the value associated with the gift by the gifter based on payment information setup with the host computing environment by the gifter;
